(19) United States
(12) Patent Application Publication
(10) Pub. No.: US 2018/0297884 A1
(43) Pub. Date: Oct. 18, 2018

(54) METHODS AND APPARATUS FOR MANUFACTURING GLASS

(71) Applicant: CORNING INCORPORATED, CORNING, NY (US)

(72) Inventors: Tomohiro Aburada, Painted Post, NY (US); Jeffrey Howard Ahrens, Pine City, NY (US); Steven Roy Burdette, Big Flats, NY (US); Nanhu Chen, Painted Post, NY (US)

(21) Appl. No.: 15/762,916

(22) PCT Filed: Sep. 23, 2016
(86) PCT No.: PCT/US2016/053507

§ 371 Date: Mar. 23, 2018

Related U.S. Application Data
(60) Provisional application No. 62/295,870, filed on Feb. 16, 2016.
(60) Provisional application No. 62/222,950, filed on Sep. 24, 2015.

(51) Int. Cl. C03B 17/06; G01B 21/08; G01B 11/06

(52) U.S. Cl. CPC C03B 17/067; G01B 11/0691; G01B 21/085; C03B 17/064

(57) ABSTRACT

A glass manufacturing apparatus includes a glass former to form a glass ribbon from a quantity of molten material, a thermal sensor oriented to sense a temperature of the glass ribbon, and a processor programmed to estimate a thickness of the glass ribbon based on the sensed temperature from the thermal sensor. A method of manufacturing glass includes forming a glass ribbon from a quantity of molten material, sensing a temperature of the glass ribbon, and estimating a thickness of the glass ribbon based on the sensed temperature.

### CROSS-REFERENCE TO RELATED APPLICATIONS

This application claims the benefit of priority under 35 U.S.C. § 119 of U.S. Provisional Application Ser. No. 62/222,950 filed on Sep. 24, 2015, and 62/295,870 filed on Feb. 16, 2016, the contents of each of which are relied upon and incorporated herein by reference in their entireties.

### FIELD

The present disclosure relates generally to apparatus and methods for manufacturing glass and, more particularly, to apparatus and methods to draw a glass ribbon from a quantity of molten material.

### BACKGROUND

Glass sheets are commonly used, for example, in display applications, including liquid crystal displays (LCDs), electrophoretic displays (EPD), organic light emitting diode displays (OLEDs), plasma display panels (PDPs), or the like. Various glass manufacturing apparatus and methods may be used to produce a glass ribbon that may be further processed into one or more glass sheets. For instance, the glass manufacturing apparatus may form a glass ribbon by a down-draw, up-draw, float, fusion, press rolling, slot draw, or other glass forming techniques.

There is a desire to closely control flow of the quantity of molten glass being drawn into the glass ribbon. Maintaining molten glass flow within a desired narrow range of acceptable molten glass flow rates can promote favorable glass ribbon attributes, for example reduced stress, desirable thickness and shape features. One possible technique for determining glass flow is weighing glass sheets that are periodically separated from the glass ribbon after the glass ribbon is cooled. However, such techniques may require special handling procedures, may damage the glass sheet, disrupt glass production, or introduce other complications. Moreover, the procedure of weighing individual glass sheets is not available in applications where the glass ribbon is wound into a spool of glass ribbon rather than being periodically cut into glass sheets. While the spool of glass ribbon itself may be weighed over time, the spool of glass ribbon may need to be located relatively far away from the location where the glass ribbon is being formed. Such remote weighing of the spool of glass ribbon may not provide acceptable responsiveness for a control system used to modify the molten glass flow rate based on information obtained from the weighing procedure. Furthermore, the edge portions of the glass ribbon may be separated prior to winding onto the spool. As such, a complicated procedure of weighing separated edge portions as well as the spool of wound glass ribbon would need to be employed. Furthermore, additional interleaf protective layer(s) may need to be added to the glass ribbon that is also wound onto the spool. As such, it may be difficult to determine the flow rate of glass being added onto the spool when other items are also being wound onto the spool as well. Thus, to provide an accurate determination of molten glass flow rate in applications where the glass ribbon is wound onto a spool, there is a benefit in determining flow rate with techniques that do not require a weight measurement of the glass ribbon. Furthermore, to enhance responsiveness of a control system, there can be a benefit in determining the glass flow rate with information obtained relatively soon after the glass ribbon is drawn from the quantity of molten material. Still further, in addition or alternatively, there may be benefits in a way to accurately determine the thickness of knurled or otherwise irregular edge portions of a glass ribbon that may otherwise be difficult to obtain with laser measurement procedures that may be used, in some embodiments, to determine the thickness of the central portion of the glass ribbon.

### SUMMARY

Techniques of the disclosure allow for estimating the molten glass flow without weighing the glass ribbon or glass sheets separated from the glass ribbon. Furthermore, estimating the molten glass flow can be achieved by measuring characteristics of the glass ribbon relatively soon after the glass ribbon is drawn from the quantity of molten glass, and more particularly, before the glass ribbon is completely cooled to the ambient temperature of the air surrounding the glass ribbon. Estimating the molten glass flow relatively soon after drawing the glass ribbon can increase responsiveness of a control system using this information to modify an upstream flow of molten glass. As such, techniques of the disclosure can help maintain glass flow within a relatively narrow range of acceptable glass flow rates.

One possible technique to determine glass flow rate relatively soon after the glass ribbon is drawn is to determine the thickness of the glass ribbon. The thickness information, together with the ribbon width and ribbon speed, can be used to calculate the volumetric flow rate of the molten glass forming the glass ribbon. Moreover, the mass flow rate of the molten glass forming the glass ribbon can also be determined by multiplying the volumetric flow rate by the density of the molten glass.

In some embodiments, thickness of a central portion of the glass ribbon may be obtained, for example, using various techniques including a thickness sensor (e.g., laser sensor, laser gauge). However, the process of drawing the glass ribbon may knurl the opposed edge portions of the glass ribbon. Consequently, the thickness of the knurled edge portions may be difficult to determine using a thickness sensor because the knurled surfaces of the edge portions of the glass ribbon may scatter a laser beam as it passes through the glass ribbon. Moreover, an inability to accurately determine the thickness of the knurled edge portions of the glass ribbon may significantly impact the estimation of the flow rate of the molten material forming the glass ribbon. For example, the edge portions of the glass ribbon can typically be relatively thicker than the central portion of the glass ribbon, and may therefore contribute to a significant portion of the calculation of the flow rate of the molten material when estimating the flow rate of the molten material forming the glass ribbon.

In further embodiments, the disclosure sets forth techniques for estimating the thickness of at least one of two opposed edge portions (e.g., knurled edge portions) of the glass ribbon. The estimated thickness of at least one edge portion can be used to more accurately estimate the overall flow of molten material forming the glass ribbon. In further embodiments, the estimated thickness of the at least one opposed edge portion can be used to determine attributes (e.g., stress) of the edge portion(s) and/or attributes of other portions of the glass ribbon. In still further embodiments, techniques for estimating the thickness of at least one of two opposed edge portions (e.g., knurled edge portions) of the glass ribbon can be used, alone or in combination, to estimate the thickness of the central portion of the glass ribbon.

Techniques for estimating the thickness of the glass ribbon, including the thickness of the edge portions of the glass ribbon and the thickness of the central portion of the glass ribbon as well as the techniques of estimating the flow rate (e.g., volumetric flow rate, mass flow rate) of the molten glass forming the glass ribbon are provided herein. The following presents a simplified summary of the disclosure to provide a basic understanding of some exemplary embodiments described in the detailed description.

In one embodiment, a glass manufacturing apparatus can include a glass former to form a glass ribbon from a quantity of molten material. The glass manufacturing apparatus can further include a thermal sensor oriented to sense a temperature of the glass ribbon and a processor programmed to estimate a thickness of the glass ribbon based on the sensed temperature from the thermal sensor.

In another embodiment, the glass manufacturing apparatus can include a controller to operate the glass former based on the estimated thickness of the glass ribbon.

In another embodiment, the thermal sensor can include an infrared sensor.

In another embodiment, the thermal sensor can include a thermal camera oriented to sense a corresponding temperature of the glass ribbon at a plurality of locations, and each of the plurality of locations can correspond to at least one pixel of the thermal camera.

In another embodiment, the thermal sensor can be oriented to sense a corresponding temperature of the glass ribbon at a plurality of locations along a first path transverse to the draw direction. The processor can be programmed to estimate a corresponding thickness of the glass ribbon at each of the plurality of locations based on the corresponding sensed temperature from the thermal sensor.

In another embodiment, the first path can extend laterally along an entire width of the glass ribbon, and the processor can be programmed to estimate a corresponding thickness of the glass ribbon at each of the plurality of locations along the entire width of the glass ribbon based on the corresponding sensed temperature from the thermal sensor.

In another embodiment, the thermal sensor can be oriented to sense a corresponding change in temperature of the glass ribbon at a plurality of locations along a plurality of second paths along the draw direction, and each of the plurality of second paths can intersect the first path. The processor can be programmed to estimate a corresponding thickness of the glass ribbon at each of the plurality of locations along the first path based on the corresponding sensed temperature of the glass ribbon at the plurality of locations along the first path from the thermal sensor and the corresponding sensed change in temperature of the glass ribbon along the plurality of second paths from the thermal sensor.

In another embodiment, the first path can extend laterally along an entire width of the glass ribbon. The processor can be programmed to estimate a corresponding thickness of the glass ribbon at each of the plurality of locations along the entire width of the glass ribbon based on the corresponding sensed temperature of the glass ribbon at the plurality of locations along the first path and the corresponding sensed change in temperature of the glass ribbon along the plurality of second paths.

In another embodiment, the thermal sensor can be oriented to sense a temperature of at least one of two opposed edge portions of the glass ribbon. The processor can be programmed to estimate a thickness of at least one of the two opposed edge portions of the glass ribbon based on the sensed temperature of the at least one of the two opposed edge portions of the glass ribbon.

In another embodiment, the glass manufacturing apparatus can further include a thickness sensor to sense a thickness of a central portion of the glass ribbon. The thermal sensor can be further oriented to sense a temperature of the central portion of the glass ribbon. The processor can be programmed to estimate the thickness of at least one of the two opposed edge portions of the glass ribbon based on the sensed temperature of the at least one of the two opposed edge portions of the glass ribbon, the sensed temperature of the central portion of the glass ribbon, and the sensed thickness of the central portion of the glass ribbon.

In some embodiments, the thickness sensor can include a laser sensor.

In another embodiment, a method of manufacturing glass can include the steps of forming a glass ribbon from a quantity of molten material, sensing a temperature of the glass ribbon, and estimating a thickness of the glass ribbon based on the sensed temperature.

In another embodiment, the method can further include the step of operating a glass former based on the estimated thickness of the glass ribbon.

In another embodiment, the method can further include the step of adjusting a flow rate of the quantity of molten material based on the estimated thickness of the glass ribbon.

In another embodiment, the method can further include the step of adjusting a temperature of the molten material based on the estimated thickness of the glass ribbon.

In another embodiment, the method can further include the step of adjusting a pull roll assembly based on the estimated thickness of the glass ribbon.

In another embodiment, the step of sensing a temperature of the glass ribbon can include sensing a corresponding temperature of the glass ribbon at a plurality of locations along a first path transverse to a draw direction of the glass ribbon, and the step of estimating the thickness of the glass ribbon can include estimating a corresponding thickness of the glass ribbon at each of the plurality of locations based on the corresponding sensed temperature.

In another embodiment, the first path can extend laterally along an entire width of the glass ribbon, and the step of estimating the thickness of the glass ribbon can include estimating a thickness of the glass ribbon at each of the plurality of locations along the entire width of the glass ribbon based on the corresponding sensed temperature.

In another embodiment, the step of sensing a temperature of the glass ribbon can include sensing a corresponding change in temperature of the glass ribbon at a plurality of locations along a plurality of second paths along the draw direction. Each of the plurality of second paths can intersect the first path, and the step of estimating the thickness of the glass ribbon can include estimating a thickness of the glass ribbon at each of the plurality of locations along the first path based on the corresponding sensed temperature of the glass ribbon at the plurality of locations along the first path and the corresponding sensed change in temperature of the glass ribbon along the plurality of second paths.

In another embodiment, the first path can extend laterally along an entire width of the glass ribbon, and the step of estimating the thickness of the glass ribbon can include estimating a thickness of the glass ribbon at each of the plurality of locations along the entire width of the glass ribbon based on the corresponding sensed temperature of the glass ribbon at the plurality of locations along the first path and the corresponding sensed change in temperature of the glass ribbon along the plurality of second paths.

In another embodiment, a method of manufacturing glass can include the step of forming a glass ribbon from a quantity of molten material. The glass ribbon can include two opposed edge portions and a central portion disposed between the two opposed edge portions. The method can further include the step of sensing a temperature of at least one of the two opposed edge portions of the glass ribbon. The method can still further include the step of estimating a thickness of at least one of the two opposed edge portions of the glass ribbon based on the sensed temperature of the at least one of the two opposed edge portions of the glass ribbon.

In another embodiment, the method can include the steps of sensing a thickness of the central portion of the glass ribbon and sensing a temperature of the central portion of the glass ribbon. The step of estimating the thickness of at least one of the two opposed edge portions of the glass ribbon can be based on the sensed temperature of the at least one of the two opposed edge portions of the glass ribbon, the sensed temperature of the central portion of the glass ribbon, and the sensed thickness of the central portion of the glass ribbon.

In another embodiment, the method can include the step of estimating a thickness of the glass ribbon along an entire width of the glass ribbon based on the sensed temperature of the at least one of the two opposed edge portions of the glass ribbon, the sensed temperature of the central portion of the glass ribbon, and the sensed thickness of the central portion of the glass ribbon.

In another embodiment, the method can include the step of operating a glass former based on the estimated thickness of the at least one of the two opposed edge portions of the glass ribbon.

In another embodiment, the method can further include the step of adjusting a flow rate of the quantity of molten material based on the estimated thickness of the at least one of the two opposed edge portions of the glass ribbon.

In another embodiment, the method can further include the step of adjusting a temperature of the molten material based on the estimated thickness of the at least one of the two opposed edge portions of the glass ribbon.

In another embodiment, the method can further include the step of adjusting a pull roll assembly based on the estimated thickness of the at least one of the two opposed edge portions of the glass ribbon.

In any of the embodiments, a processor may be programmed to estimate the thickness (t) of the glass ribbon and/or a method may estimate the thickness (t) of the glass ribbon as a function of the relationship:

$$\frac{t}{2} v ρ {C}_{p} ( \frac{d}{dy} T ) = - h ( T - {T}_{a} ) + ɛσ ( {T}^{4} - {T}_{a}^{4} )$$

or as a function of the relationship:

$$\frac{t}{2} v ρ {C}_{p} ( \frac{d}{dy} T ) = - h ( T - {T}_{a} ) + ɛσ ( {T}^{4} - {T}_{a}^{4} ) + k$$

where, in the above relationships: v represents a velocity of the glass ribbon along a draw direction; ρ represents a density of a material of the glass ribbon; Cₚ represents a heat capacity of the material of the glass ribbon; y represents a coordinate in the draw direction; T represents a sensed temperature of the glass ribbon; h represents a convective heat transfer coefficient of the glass ribbon; Tₐ represents a temperature of an ambient and radiative environment of the glass ribbon; ε represents an emissivity of the glass ribbon; a represents the Stefan-Boltzmann constant; and k represents an optional corrective term of the convective heat transfer coefficient.

In any of the embodiments, the processor may be programmed to estimate the convective heat transfer coefficient (h) and/or the method may estimate the convective heat transfer coefficient (h) as a function of the relationship:

$$h = \frac{ɛσ ( {T}^{4} - {T}_{a}^{4} ) - \frac{τ}{2} v ρ {C}_{p} ( \frac{d}{dy} T )}{( T - {T}_{a} )}$$

or as a function of the relationship

$$h = \frac{ɛσ ( {T}^{4} - {T}_{a}^{4} ) + k - \frac{τ}{2} v ρ {C}_{p} ( \frac{d}{dy} T )}{( T - {T}_{a} )}$$

where, in the above relationships, τ represents a sensed thickness of the glass ribbon; v represents a velocity of the glass ribbon along the draw direction; ρ represents a density of a material of the glass ribbon; Cₚ represents a heat capacity of the material of the glass ribbon; y represents a coordinate in the draw direction; T represents a sensed temperature of the glass ribbon; h represents a convective heat transfer coefficient of the glass ribbon; Tₐ represents a temperature of an ambient and radiative environment of the glass ribbon; ε represents an emissivity of the glass ribbon; σ represents the Stefan-Boltzmann constant; and k represents an optional corrective term of the convective heat transfer coefficient.

In any of the embodiments, the processor may be programmed to estimate the corrective term (k) of the convective heat transfer coefficient and/or the method may estimate the corrective term (k) of the convective heat transfer coefficient, if provided, to be within a range of:

$$0 \leq k \leq \frac{c}{2} ( τ \frac{{d}^{2} T}{{dx}^{2}} + \frac{d τ}{dx} \frac{dT}{dx} )$$

where, τ represents a sensed thickness of the glass ribbon; T represents a sensed temperature the glass ribbon; c represents a thermal conductivity coefficient of the material of the glass ribbon; x represents a coordinate transverse to the draw direction.

It is to be understood that both the foregoing general description and the following detailed description present embodiments of the present disclosure, and are intended to provide an overview or framework for understanding the nature and character of the embodiments as they are described and claimed. The accompanying drawings are included to provide a further understanding of the embodiments, and are incorporated into and constitute a part of this specification. The drawings illustrate various embodiments of the disclosure, and together with the description, serve to explain the principles and operations thereof.

### BRIEF DESCRIPTION OF THE DRAWINGS

The above and other features, embodiments, and advantages of the present disclosure are better understood when the following detailed description is read with reference to the accompanying drawings, in which:

FIG. 1 schematically illustrates an exemplary glass manufacturing apparatus for manufacturing glass;

FIG. 2 illustrates a cross-sectional perspective view of the glass manufacturing apparatus along line 2-2 of FIG. 1;

FIG. 3 schematically illustrates a glass ribbon being further processed during exemplary methods of manufacturing glass;

FIG. 4 is a cross sectional view along line 4-4 of FIG. 1 schematically illustrating a thermal sensor sensing a temperature of an edge portion of the glass ribbon;

FIG. 5 is a graph representing glass flow with respect to time of an actual glass flow rate compared to an estimated glass flow rate wherein the thicknesses of the edge portions were assumed to be a certain multiple of the thickness of the central portion; and

FIG. 6 is a graph representing glass flow with respect to time of an actual glass flow rate compared to an estimated glass flow rate based on a sensed temperature of the glass ribbon.

### DETAILED DESCRIPTION

Apparatus and methods will now be described more fully hereinafter with reference to the accompanying drawings in which exemplary embodiments of the disclosure are shown. Whenever possible, the same reference numerals are used throughout the drawings to refer to the same or like parts. However, this disclosure may be embodied in many different forms and should not be construed as limited to the embodiments set forth herein.

Various glass manufacturing apparatus and methods of the disclosure may be used to produce a glass ribbon that may be further processed into one or more glass sheets. For instance, the glass manufacturing apparatus may form a glass ribbon by a down-draw, up-draw, float, fusion, press rolling, slot draw, or other glass forming techniques. By way of embodiments, exemplary down-draw apparatus and methods are described and illustrated although other glass manufacturing techniques may be used in further embodiments.

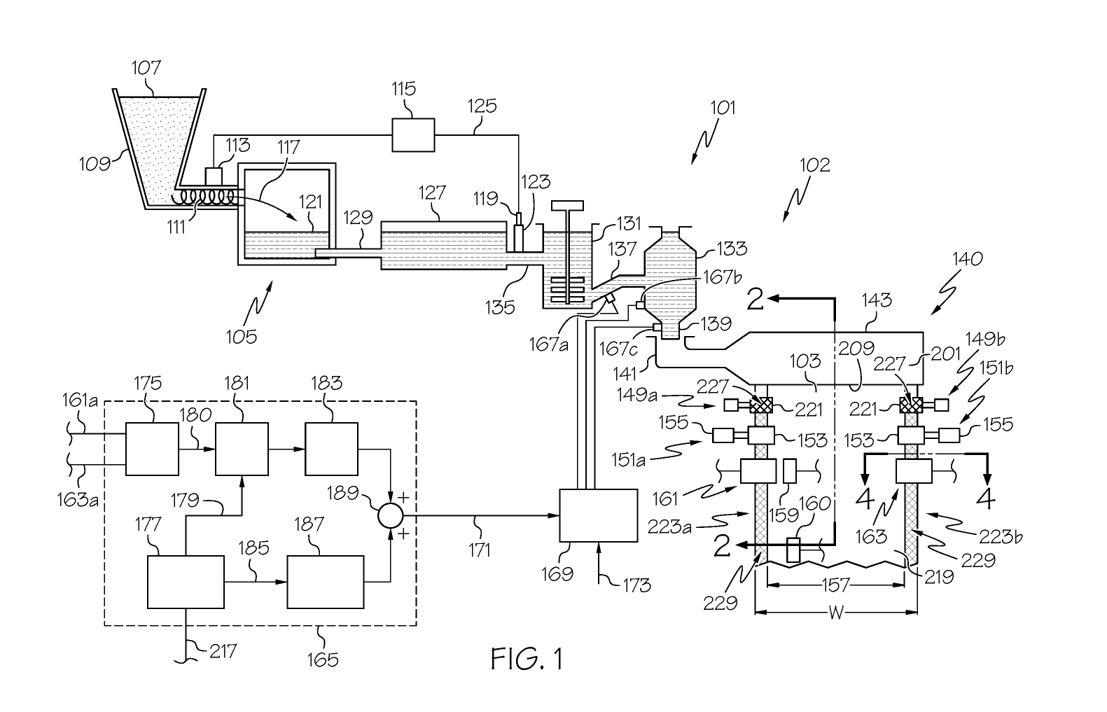

FIG. 1 schematically illustrates an exemplary glass manufacturing apparatus 101 including a glass former 102 to draw a glass ribbon 103. For illustration purposes, the glass manufacturing apparatus 101, including the glass former 102, is illustrated as a fusion down-draw apparatus, although other glass manufacturing apparatus for up-draw, float, press rolling, slot draw, etc. may be provided in further embodiments. As illustrated, the glass manufacturing apparatus 101 can include a melting vessel 105 oriented to receive batch material 107 from a storage bin 109. The batch material 107 can be introduced by a batch delivery device 111 powered by a motor 113. An optional controller 115 can be operated to activate the motor 113 to introduce a desired amount of batch material 107 into the melting vessel 105, as indicated by arrow 117. A glass melt probe 119 can be used to measure a level of molten material 121 within a standpipe 123 and communicate the measured information to the controller 115 by way of a communication line 125.

The glass manufacturing apparatus 101 can also include a fining vessel 127 located downstream from the melting vessel 105 and coupled to the melting vessel 105 by way of a first connecting conduit 129. In some embodiments, molten material 121 may be gravity fed from the melting vessel 105 to the fining vessel 127 by way of the first connecting conduit 129. For instance, gravity may act to drive the molten material 121 to pass through an interior pathway of the first connecting conduit 129 from the melting vessel 105 to the fining vessel 127. Within the fining vessel 127, bubbles may be removed from the molten material 121 by various techniques.

The glass manufacturing apparatus 101 can further include a mixing chamber 131 that may be located downstream from the fining vessel 127. The mixing chamber 131 can be used to provide a homogenous composition of molten material 121, thereby reducing or eliminating cords of inhomogeneity that may otherwise exist within the molten material 121 exiting the fining vessel 127. As shown, the fining vessel 127 may be coupled to the mixing chamber 131 by way of a second connecting conduit 135. In some embodiments, molten material 121 may be gravity fed from the fining vessel 127 to the mixing chamber 131 by way of the second connecting conduit 135. For instance, gravity may drive the molten material 121 to pass through an interior pathway of the second connecting conduit 135 from the fining vessel 127 to the mixing chamber 131.

The glass manufacturing apparatus 101 can further include a delivery vessel 133 that may be located downstream from the mixing chamber 131. The delivery vessel 133 may condition the molten material 121 to be fed into a glass former 140. For instance, the delivery vessel 133 can function as an accumulator and/or flow controller to adjust and provide a consistent flow of molten material 121 to the glass former 140. As shown, the mixing chamber 131 may be coupled to the delivery vessel 133 by way of a third connecting conduit 137. In some embodiments, molten material 121 may be gravity fed from the mixing chamber 131 to the delivery vessel 133 by way of the third connecting conduit 137. For instance, gravity may drive the molten material 121 to pass through an interior pathway of the third connecting conduit 137 from the mixing chamber 131 to the delivery vessel 133.

As further illustrated, a delivery pipe 139 can be positioned to deliver molten material 121 to the glass former 140 of the glass manufacturing apparatus 101. As discussed more fully below, the glass former 140 may draw the molten material 121 into the glass ribbon 103 off of a root 209 of a forming vessel 143. In the illustrated embodiment, the forming vessel 143 can be provided with an inlet 141 oriented to receive molten material 121 from the delivery pipe 139 of the delivery vessel 133.

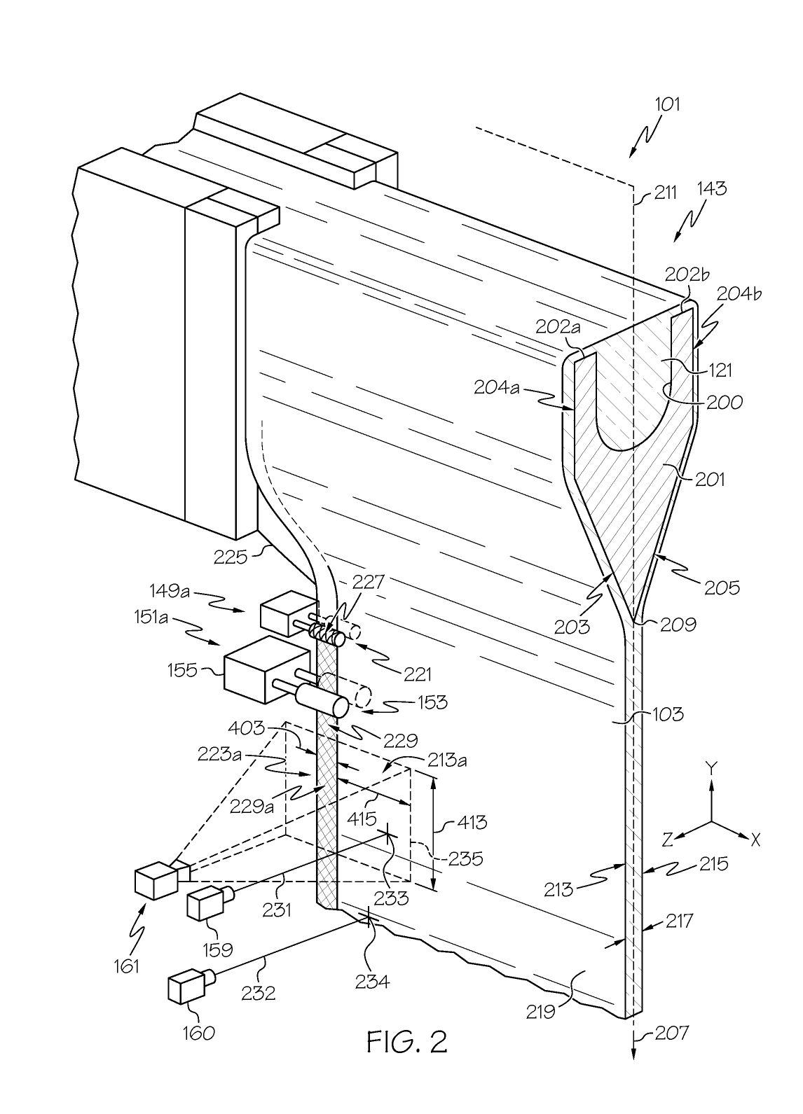

FIG. 2 is a cross-sectional perspective view of the glass manufacturing apparatus 101 along line 2-2 of FIG. 1. As shown, the forming vessel 143 can include a forming wedge 201 including a pair of downwardly inclined converging surface portions 203, 205 extending between opposed ends of the forming wedge 201. The pair of downwardly inclined converging surface portions 203, 205 can converge along a draw direction 207 to form the root 209. A draw plane 211 extends through the root 209 wherein the glass ribbon 103 may be drawn in the draw direction 207 along the draw plane 211. As shown, the draw plane 211 can bisect the root 209, although the draw plane 211 may extend at other orientations with respect to the root 209 in further embodiments.

Referring to FIG. 2, in one embodiment, the molten material 121 can flow into a trough 200 of the forming vessel 143. The molten material 121 can then simultaneously flow over corresponding weirs 202a, 202b and downward over the outer surfaces 204a, 204b of the corresponding weirs 202a, 202b. Respective streams of molten material 121 can then flow along the downwardly inclined converging surface portions 203, 205 of the forming wedge 201 to the root 209 of the forming vessel 143, where the flows converge and fuse into the glass ribbon 103. The glass ribbon 103 may then be fusion drawn off the root 209 in the draw plane 211 along draw direction 207.

As shown, the glass ribbon 103 can be drawn from the root 209 with a first major surface 213 and a second major surface 215 each having a width corresponding to a width “W” of the glass ribbon 103. As shown, the first major surface 213 and the second major surface 215 can face opposite directions with a thickness 217 of a central portion 219 of the glass ribbon 103 defined between the first major surface 213 and the second major surface 215. The thickness 217 of the central portion 219 of the glass ribbon 103 can be substantially the same across a transverse width 157 of the central portion 219 of the glass ribbon 103 perpendicular to the draw direction 207. Moreover, the thickness 217 of the central portion 219 of the glass ribbon 103 can be maintained substantially the same as the glass ribbon 103 is drawn such that the central portion 219 of the glass ribbon 103 has a consistent thickness 217 along the entire area of the central portion 219 of the glass ribbon 103. In some embodiments, the thickness 217 of the central portion 219 of the glass ribbon 103 can be less than or equal to about 1 millimeter (mm), for example, from about 50 micrometers (μm) to about 750 μm, for example from about 100 μm to about 700 μm, for example from about 200 μm to about 600 μm, for example from about 300 μm to about 500 μm.

In some embodiments, the glass manufacturing apparatus 101 for fusion drawing a glass ribbon 103 can also include at least one edge roll assembly 149a, 149b. Each illustrated edge roll assembly 149a, 149b can be identical with one another, although different edge roll assembly configurations may be used in further embodiments. As shown in FIG. 2, each edge roll assembly 149a, 149b can include a pair of edge rolls 221 with a corresponding one of two opposed edge portions 223a, 223b (see FIG. 1) of the glass ribbon 103 pinched between each pair of edge rolls 221. As shown in FIG. 1, a first edge roll assembly 149a (with a pair of edge rolls 221) can be associated with a first edge portion 223a of the two opposed edge portions 223a, 223b of the glass ribbon 103. As further shown in FIG. 1, a second edge roll assembly 149b (with a pair of edge rolls 221) can be associated with a second edge portion 223b of the two opposed edge portions 223a, 223b of the glass ribbon 103. In the illustrated embodiment, the edge rolls 221 can freely rotate although, in other embodiments, the edge rolls 221 may be driven rolls (e.g., driven by one or more motors).

Each of the opposed edge portions 223a, 223b of the glass ribbon 103 can be drawn through the corresponding pair of edge rolls 221 as the glass ribbon 103 is drawn off the root 209 of the forming wedge 201. Each pair of edge rolls 221 can provide proper finishing of the corresponding opposed edge portions 223a, 223b of the glass ribbon 103. Indeed, edge roll finishing of the opposed edge portions 223a, 223b with the corresponding pairs of edge rolls 221 can provide desired edge characteristics and proper fusion of the opposed edge portions 223a, 223b of the molten glass being pulled off opposed surfaces of respective edge directors 225 at each end of the forming wedge 201 (one shown in FIG. 2). As shown in FIGS. 1 and 2, at least one or both of the edge rolls of the pairs of edge rolls 221 can include a knurled surface 227 that may finish one or both opposed surfaces of each of the opposed edge portions 223a, 223b of the glass ribbon 103 with a corresponding knurled surface 229 stamped into the glass surfaces of the edge portions 223a, 223b of the glass ribbon 103 as the edge portions 223a, 223b are finished with the pairs of edge rolls 221 of each edge roll assembly 149a, 149b.

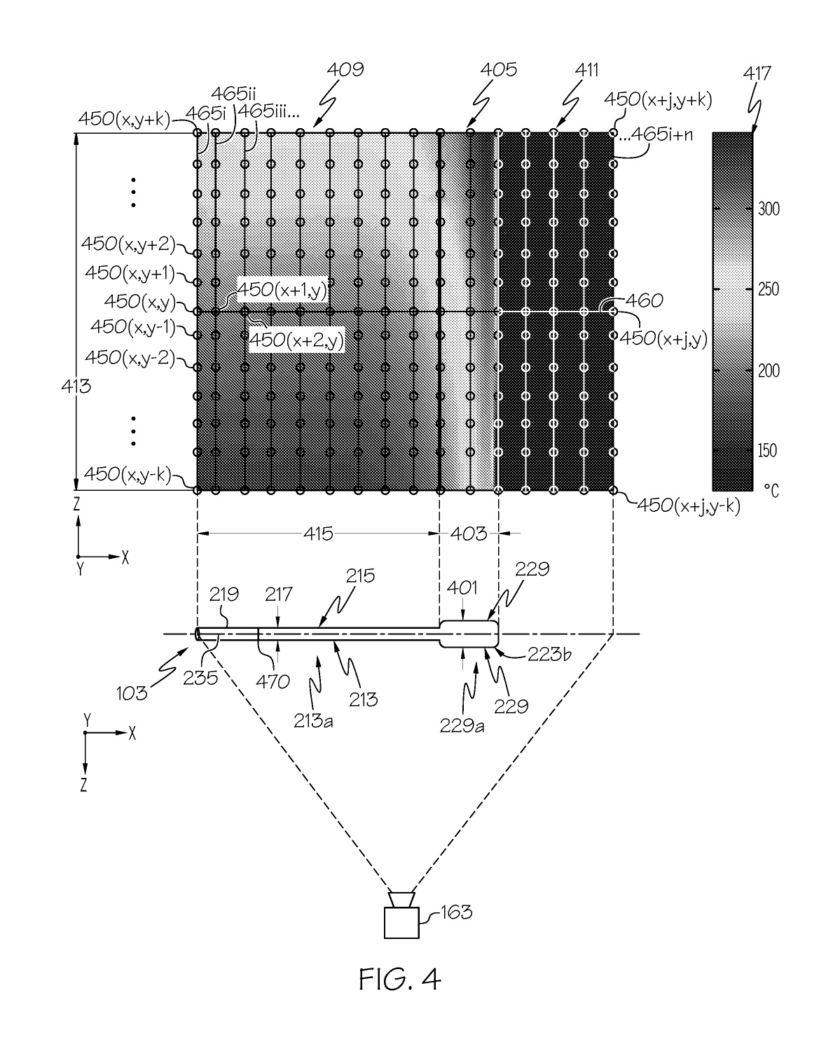

As shown in FIG. 1, the opposed edge portions 223a, 223b of the glass ribbon 103 can be substantially identical to one another, although the edge portions 223a, 223b can have different configurations in further embodiments. As illustrated, the central portion 219 of the glass ribbon 103 can be disposed between the two opposed edge portions 223a, 223b of the glass ribbon 103. In some embodiments, the two opposed edge portions 223a, 223b of the glass ribbon 103 may each have a thickness 401 (see FIG. 4) that is greater than the thickness 217 of the central portion 219 of the glass ribbon 103. In one embodiment, the thickness 401 can be greater than or equal to 1 mm, from about 1 mm to about 2 mm, although other thicknesses may be provided in further embodiments. For example, the thickness 401 can be between about 0.1 mm to about 0.3 mm, between about 0.3 mm to about 2 mm, between about 0.1 mm to about 0.6 mm, or between about 0.3 mm and about 0.7 mm, and all subranges therebetween.

FIG. 4 illustrates representative features of the second edge portion 223b of the glass ribbon 103 with the understanding that the first edge portion 223a of the glass ribbon 103 may be identical to or similar to the second edge portion 223b of the glass ribbon 103. As shown in FIG. 4, the second edge portion 223b of the glass ribbon 103 may include a thickness 401 that can vary across the width 403 of the second edge portion 223b of the glass ribbon 103. For example, the thickness 401 may vary between peaks and valleys of the knurled surfaces 229 of the second edge portion 223b of the glass ribbon 103. Moreover, the average thickness may vary across the width 403 of the second edge portion 223b of the glass ribbon 103. As such, each edge portion 223a, 223b of the glass ribbon 103 may be considered to have a unique thickness trace that can include a thickness profile across the width 403 of the respective edge portions 223a, 223b of the glass ribbon 103.

As further shown in FIGS. 1 and 2, the glass manufacturing apparatus 101 can further include a first and second pull roll assembly 151a, 151b for each respective edge portion 223a, 223b of the glass ribbon 103 to facilitate pulling of the glass ribbon 103 in the draw direction 207 of the draw plane 211. Each illustrated pull roll assembly 151a, 151b can be identical with one another, although different pull roll assembly configurations may be used in further embodiments. As shown in FIG. 2, each pull roll assembly 151a, 151b can include a pair of pull rolls 153 with a corresponding one of two opposed edge portions 223a, 223b (see FIG. 1) of the glass ribbon 103 pinched between each pair of pull rolls 153. As shown in FIG. 1, a first pull roll assembly 151a (with a pair of pull rolls 153) can be associated with the first edge portion 223a of the two opposed edge portions 223a, 223b of the glass ribbon 103. As further shown in FIG. 1, a second pull roll assembly 151b (with a pair of pull rolls 153) can be associated with the second edge portion 223b of the two opposed edge portions 223a, 223b of the glass ribbon 103. In the illustrated embodiment, the pair of pull rolls 153 can be driven by one or more motors 155.

Each of the opposed edge portions 223a, 223b of the glass ribbon 103 can be drawn through the corresponding pair of pull rolls 153 as the glass ribbon 103 is drawn off the root 209 of the forming wedge 201. The pair of pull rolls 153 may be driven by the motors 155 to provide appropriate tension within the glass ribbon 103 and therefore facilitate drawing of the glass ribbon 103 at an appropriate rate to provide desired glass ribbon attributes, including a thickness of the glass ribbon 103. The knurled surfaces 229 of the two opposed edge portions 223a, 223b of the glass ribbon 103 can increase the coefficient of friction of the opposed edge portions 223a, 223b of the glass ribbon 103 and therefore provide appropriate gripping between the pull rolls 153 and the opposed edge portions 223a, 223b of the glass ribbon 103. As such, slipping between the pull rolls 153 and the knurled surfaces 229 of the opposed edge portions 223a, 223b of the glass ribbon 103 can be reduced or prevented to provide a precise and consistent pulling force to the glass ribbon 103.

Therefore, the knurled surfaces 229 of the glass ribbon 103 can help finish the opposed edge portions 223a, 223b of the glass ribbon 103 and increase friction between the surfaces of the opposed edge portions 223a, 223b and the pull rolls 153. However, the knurled surfaces 229 of the glass ribbon 103 can complicate a calculation of molten glass flow based on the thickness of the glass ribbon 103. For example, a thickness sensor 159 (e.g., laser sensor, laser gauge, or other suitable sensor) may be used to determine the thickness 217 of the central portion 219 of the glass ribbon 103. Indeed, the central portion 219 of the glass ribbon 103 can include untouched pristine major surfaces 213, 215 of the glass ribbon 103. The pristine major surfaces 213, 215 of the glass ribbon 103 can provide ideal surfaces for reflecting light that allows for measurement of the thickness 217 of the central portion 219 of the glass ribbon 103. However, measurement of the knurled surfaces 229 of the opposed edge portions 223a, 223b of the glass ribbon 103 may be difficult as the knurled surfaces 229 may diffuse or otherwise interfere with the measurement device (e.g., laser) as it encounters the features of the knurled surfaces 229 of the opposed edge portions 223a, 223b of the glass ribbon 103.

Referring to FIG. 1, the product of the width “W” of the glass ribbon 103 and the thickness of the glass ribbon 103 can determine the overall cross sectional area (Aₒᵥₑᵣₐₗₗ) of the glass ribbon 103. The speed “S” that the glass ribbon 103 is drawn in the draw direction 207 can also be measured. Consequently, the overall volumetric flow rate (Vₒᵥₑᵣₐₗₗ) of the molten glass 121 forming the glass ribbon 103 can be calculated as (Vₒᵥₑᵣₐₗₗ)=(S)×(Aₒᵥₑᵣₐₗₗ), and the overall mass flow rate of the molten glass 121 forming the glass ribbon 103 can be calculated as (mₒᵥₑᵣₐₗₗ) (ρ)×(Vₒᵥₑᵣₐₗₗ), where (p) represents the density of molten material 121 forming the glass ribbon 103. Likewise, the product of the width 157 of the central portion 219 of the glass ribbon 103 and the measured thickness 217 of the central portion 219 of the glass ribbon 103 can determine the cross sectional area (A_{central}) of the central portion 219 of the glass ribbon 103. The volumetric flow rate of the molten glass 121 forming the central portion 219 of the glass ribbon 103 can be calculated as (V_{central})=(S)×(A_{central}), and the mass flow rate of the molten glass 121 forming the central portion 219 of the glass ribbon 103 can be calculated as (m_{central})=(ρ)×(V_{central}).

The present disclosure also provides techniques for estimating the thickness 401 of the opposed edge portions 223a, 223b of the glass ribbon 103 without directly measuring the thickness 401 of the opposed edge portions 223a, 223b of the glass ribbon 103 (e.g., with a laser). The estimated thickness 401 of the edge portions 223a, 223b of the glass ribbon 103 can facilitate a relatively accurate estimate of the flow rate (e.g., volumetric flow rate, mass flow rate) of the molten glass 121 forming the edge portions 223a, 223b of the glass ribbon 103. Indeed, the product of the width 403 of the edge portions 223a, 223b of the glass ribbon 103 and the estimated thickness 401 of the edge portions 223a, 223b of the glass ribbon 103 can determine the estimated cross sectional area (A_{edge1}) of the first edge portion 223a of the glass ribbon 103 and the estimated cross sectional area (A_{edge2}) of the second edge portion 223b of the glass ribbon 103. Consequently, the volumetric flow rate of each of the edge portions 223a, 223b of the glass ribbon 103 can be calculated as (V_{edge1})=(S)×(A_{edge1}) and (V_{edge2}) (S)×(A_{edge2}), and the mass flow rate of the molten glass 121 forming each of the edge portions 223a, 223b of the glass ribbon 103 can be calculated as (m_{edge1}) (ρ)×(V_{edge1}) and (m_{edge2})=(ρ)×(V_{edge2}).

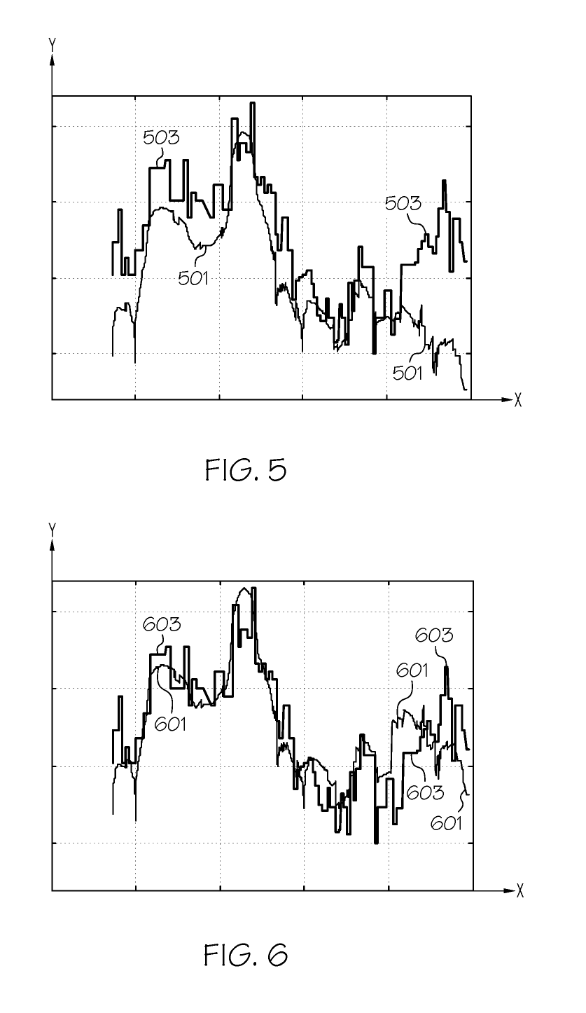

The overall volumetric flow rate (Vₒᵥₑᵣₐₗₗ) of the molten glass 121 forming the glass ribbon 103 can be calculated as (Vₒᵥₑᵣₐₗₗ)=(V_{central})+(V_{edge1})+(V_{edge2}), and the overall mass flow rate of the molten glass 121 forming the glass ribbon 103 can be calculated as (mₒᵥₑᵣₐₗₗ)=(ρ)×(Vₒᵥₑᵣₐₗₗ). In some embodiments, if the cross-sectional area of the edge portions 223a, 223b of the glass ribbon 103 are substantially identical (e.g., (A_{edge})=(A_{edge1})=(A_{edge2})), the volumetric flow rate of one of the edge portions can be doubled such that (Vₒᵥₑᵣₐₗₗ)=(V_{central})+(2V_{edge}). While the width 403 of the edge portion 223a, 223b of the glass ribbon 103 may be easily measured or otherwise determined, as mentioned above, the thickness of the edge portions 223a, 223b of the glass ribbon 103 may be difficult to determine because laser light produced by the thickness sensor 159, in some embodiments, may be diffused by the knurled surfaces 229 of the edge portions 223a, 223b of the glass ribbon 103. In some embodiments, the (V_{edge}) may be estimated by assuming the (V_{edge}) is a certain percentage of the thickness 217 of the central portion 219 of the glass ribbon 103 (e.g., a certain percentage greater than the measured thickness 217 of the central portion 219 of the glass ribbon 103). However, for some applications, such estimation techniques may not provide a sufficient level of accuracy as discussed with respect to FIG. 5 below.

In embodiments where the thickness of the glass ribbon 103 is uniform across an entire width “W” of the glass ribbon 103, a single measurement or a single estimation of the thickness of the glass ribbon 103 at a single location on the glass ribbon 103 could accurately represent the thickness of the glass ribbon 103 across the entire width “W” of the glass ribbon 103. However, in some embodiments, the thickness 401 of the edge portions 223a, 223b of the glass ribbon 103 as well as the thickness 217 of the central portion 219 of the glass ribbon 103 can vary across the width “W” of the glass ribbon 103 and can also vary at different elevations on the glass ribbon 103 (e.g., along the draw direction 207 of the glass ribbon 103). Therefore, in some embodiments, the present disclosure provides more accurate estimation of the thickness of the glass ribbon 103 and, in turn, more accurate estimation of the flow rate of the molten glass 121 used to produce the glass ribbon 103. This may be true even in applications where the edge portions 223a, 223b of the glass ribbon 103 may include knurled surfaces 229 and in applications where the thickness 401 of the edge portions 223a, 223b of the glass ribbon 103 as well as the thickness 217 of the central portion 219 of the glass ribbon 103 may vary across the width “W” of the glass ribbon 103 and/or vary at different elevations on the glass ribbon 103 (e.g., along the draw direction 207 of the glass ribbon 103).

Accordingly, in some embodiments, the thickness of the glass ribbon 103 can be estimated at a plurality of discretized locations on the glass ribbon 103. In some embodiments, increasing the number of the plurality of discretized locations at which the thickness of the glass ribbon 103 can be estimated can improve a precision of the estimation. The methods and apparatus of the present disclosure are to be understood to encompass estimation of the thickness of the glass ribbon 103 at any number of discretized locations on the glass ribbon 103, including a single location and a plurality of locations. Thus any level of refinement of the discretization of the estimation of the thickness of the glass ribbon 103 is within the scope of the disclosure and should not be limited based on specific embodiments disclosed herein, unless otherwise noted.

As schematically shown in FIGS. 1-2, the glass manufacturing apparatus 101 can include a thickness sensor 159, 160 oriented to sense the thickness 217 of the central portion 219 of the glass ribbon 103. The thickness sensor 159, 160 can include solid probes that contact the major surfaces 213, 215 of the glass ribbon 103 to measure the thickness 217 of the central portion 219 of the glass ribbon 103. In such embodiments, the probe(s) may be formed from self-lubricating materials or other materials that minimize or prevent contact damage to the pristine quality of the major surfaces 213, 215 of the glass ribbon 103. In further embodiments, the thickness sensor 159, 160 can include a sensor that senses the thickness 217 of the central portion 219 of the glass ribbon 103 without contacting the major surfaces 213, 215 of the glass ribbon 103 with a solid object. For instance, the thickness sensor 159, 160 can employ fluid (e.g., gas) to sense the thickness 217 of the central portion 219 of the glass ribbon 103 based on feedback (e.g., pressure feedback) from a fluid stream impacting the major surfaces 213, 215 of the glass ribbon 103. In further embodiments, the thickness sensor 159, 160 may include acoustic probes that sense the thickness 217 of the central portion 219 of the glass ribbon 103 by bouncing acoustic waves off of the major surfaces 213, 215 of the glass ribbon 103.

As illustrated schematically in FIGS. 1 and 2, in still another embodiment, the thickness sensor 159, 160 can include the illustrated laser sensor. Various other sensors including suitable laser sensors may be incorporated in accordance with embodiments of the disclosure that emit at least one laser beam to interact with at least one major surface 213, 215 of the glass ribbon 103 to measure the thickness 217 of the central portion 219 of the glass ribbon 103. In one embodiment, as schematically shown in FIG. 2, the thickness sensor 159 may emit a laser beam 231 toward the glass ribbon 103. The laser beam 231 may contact the first major surface 213 of the glass ribbon 103 at a location 233 (marked by the “+” shown in FIG. 2). A portion of the laser beam 231 can reflect from the first major surface 213 of the glass ribbon 103 back to the thickness sensor 159. Another portion of the laser beam 231 can be transmitted through the thickness 217 of the central portion 219 of the glass ribbon 103 and can also be reflected from the second major surface 215 of the glass ribbon 103 and back to the thickness sensor 159. The thickness sensor 159 can then calculate the thickness 217 of the central portion 219 of the glass ribbon 103 based on information obtained from the reflected portions of the laser beam 231.

In some embodiments, the thickness sensor 159, 160 can be stationary and can sense a thickness 217 of the central portion 219 of the glass ribbon 103 at a particular spatial location on the glass ribbon 103. In some embodiments, the sensed thickness 217 of the central portion 219 of the glass ribbon 103 at the particular spatial location on the glass ribbon 103 can be used as an estimation of the thickness 217 of the central portion 219 of the glass ribbon 103 across a portion of the transverse width 157 of the central portion 219 of the glass ribbon 103 or as an estimation of the thickness 217 of the central portion 219 of the glass ribbon 103 across an entire transverse width 157 of the central portion 219 of the glass ribbon 103. In other embodiments, a plurality of stationary thickness sensors 159, 160 can be mounted (e.g., on a frame) to sense a corresponding plurality of thicknesses 217 of the central portion 219 of the glass ribbon 103 at a corresponding plurality of spatial locations on the glass ribbon 103. In some embodiments, the sensed thickness 217 of the central portion 219 of the glass ribbon 103 at the corresponding plurality of spatial locations on the glass ribbon 103 can be used as an estimation of the thickness 217 of the central portion 219 of the glass ribbon 103 across a portion of the transverse width 157 of the central portion 219 of the glass ribbon 103 or as an estimation of the thickness 217 of the central portion 219 of the glass ribbon 103 across an entire transverse width 157 of the central portion 219 of the glass ribbon 103. For example, the sensed thickness 217 of the central portion 219 of the glass ribbon 103 at the corresponding plurality of spatial locations on the glass ribbon 103 can, in some embodiments, be averaged, extrapolated, and numerically manipulated to estimate the thickness 217 of the central portion 219 of the glass ribbon 103 across a portion of the transverse width 157 of the central portion 219 of the glass ribbon 103. In addition or alternatively, the sensed thickness 217 of the central portion 219 of the glass ribbon 103 at the corresponding plurality of spatial locations on the glass ribbon 103 can, in some embodiments, be averaged, extrapolated, and numerically manipulated to estimate the thickness 217 of the central portion 219 of the glass ribbon 103 across an entire transverse width 157 of the central portion 219 of the glass ribbon 103.

In other embodiments, the thickness sensor 159, 160 can traverse across a width “W” of the glass ribbon 103 (e.g., across the transverse width 157 of the central portion 219 of the glass ribbon 103) to sense a thickness 217 of the central portion 219 of the glass ribbon 103. In some embodiments, a single thickness sensor 159, 160 or a plurality of thickness sensors 159, 160 can be mounted on a mechanical track (not shown) that moves the thickness sensor 159, 160 or the plurality of thickness sensors 159, 160 back and forth across the transverse width 157 of the central portion 219 of the glass ribbon 103 to repeatedly sense a plurality of thicknesses 217 of the central portion 219 of the glass ribbon 103. The thickness sensor 159, 160 can sense a thickness 217 of the central portion 219 of the glass ribbon 103 as the glass ribbon 103 is drawn in the draw direction 207, and can therefore sense the thickness 217 of the central portion 219 of the glass ribbon 103 across the transverse width 157 of the central portion 219 of the glass ribbon 103 at a plurality of cross-sectional elevations along the draw direction 207 of the glass ribbon 103. In some embodiments, the sensed thickness 217 of the central portion 219 of the glass ribbon 103 at the corresponding plurality of spatial locations on the glass ribbon 103 can be averaged, extrapolated, and numerically manipulated to estimate the thickness 217 of the central portion 219 of the glass ribbon 103 across a portion of or the entire transverse width 157 of the central portion 219 of the glass ribbon 103.

The glass manufacturing apparatus 101 can further include at least one thermal sensor 161, 163 to sense a temperature (e.g., an absolute temperature, a difference in temperature, infrared radiation reflected by an object, infrared radiation absorbed by an object, and any other thermal characteristic) of the glass ribbon 103. As will be discussed more fully below, in some embodiments, a thickness of the glass ribbon 103 can also be estimated based on a temperature of the glass ribbon 103. Accordingly, the thermal sensor 161, 163 will be described herein as sensing a temperature, with the understanding that the sensed temperature can include any one or more of an absolute temperature, a difference in temperature, infrared radiation reflected by an object, infrared radiation absorbed by an object, and any other thermal characteristic of or relating to a temperature. In some embodiments, the at least one thermal sensor 161, 163 can sense a temperature of at least one of the two opposed edge portions 223a, 223b of the glass ribbon 103 and a temperature of the central portion 219 of the glass ribbon 103. The at least one thermal sensor 161, 163 can include a wide range of sensors. In the illustrated embodiment, the thermal sensors 161, 163 can include identical sensors, although different sensors may be provided in further embodiments. As such, the description of the first thermal sensor 161 can apply equally to the second thermal sensor 163. In one embodiment, as shown in FIGS. 1-4, the thermal sensor 161, 163 can include at least one infrared sensor (e.g., thermal camera) to capture an infrared image. In other embodiments, the thermal sensor 161, 163 can include any one or more of a pyrometer, an array of pyrometers, an infrared scanner, an array of infrared scanners, or any other suitable thermal sensor.

Various temperatures may be monitored in accordance with embodiments of the disclosure. For instance, the temperature can include a temperature at a single point (e.g., pixel) corresponding to one or more coordinate locations of one or more points on the edge portions 223a, 223b of the glass ribbon 103 and/or one or more coordinate locations of one or more points on the central portion 219 of the glass ribbon 103. For example, point 450(x, y) is identified in FIG. 4 as a representation of a temperature at a single point (e.g., pixel) corresponding to a coordinate location (e.g., x, y) of a position on the glass ribbon 103. Furthermore, the temperature can include a temperature at any one or more of a plurality of points illustrated in FIG. 4 as points 450(x, y); 450(x, y+1), 450(x, y+2), . . . 450(x, y+k); 450(x, y−1), 450(x, y−2), . . . 450(x, y−k); 450(x+1, y), 450(x+2, y), . . . 450(x+j, y); 450(x+j, y+k); and 450(x+j, y−k) corresponding to coordinate locations (e.g., x, y) on the edge portions 223a, 223b of the glass ribbon 103 and on the central portion 219 of the glass ribbon 103.

Referring to FIG. 4, in another embodiment, the thermal sensor 161, 163 can be oriented to sense a corresponding change in temperature (dT/dy) of the glass ribbon 103 at a plurality of locations (e.g., points 450(x, y); 450(x, y+1), 450(x, y+2), . . . 450(x, y+k); 450(x, y−1), 450(x, y−2), . . . 450(x, y−k); 450(x+1, y), 450(x+2, y), . . . 450(x+j, y); 450(x+j, y+k); and 450(x+j, y−k) along a plurality of second paths 465i, 465ii, 465iii, . . . 465i+n along the draw direction 207. As shown, each of the plurality of second paths 465i, 465ii, 465iii, . . . 465i+n can intersect the first path 460, and the processor 165 can be programmed to estimate a corresponding thickness (e.g., thickness 217, thickness 401) of the glass ribbon 103 at each of the plurality of locations (e.g., points 450(x, y), 450(x+1, y), 450(x+2, y), . . . 450(x+j, y)) along the first path 460 based on the corresponding sensed temperature of the glass ribbon 103 at the plurality of locations (e.g., points 450(x, y), 450(x+1, y), 450(x+2, y), . . . 450(x+j, y)) along the first path 460 from the thermal sensor 161, 163 and the corresponding sensed change in temperature (dT/dy) of the glass ribbon 103 at the plurality of locations (e.g., points 450(x, y); 450(x, y+1), 450(x, y+2), . . . 450(x, y+k); 450(x, y−1), 450(x, y−2), . . . 450(x, y−k); 450(x+1, y), 450(x+2, y), . . . 450(x+j, y); 450(x+j, y+k); and 450(x+j, y−k) along the plurality of second paths 465i, 465ii, 465iii, . . . 465i+n from the thermal sensor 161, 163. In another embodiment, the first path 460 can extend laterally along an entire width “W” of the glass ribbon 103, and the processor 165 can be programmed to estimate a corresponding thickness of the glass ribbon 103 at each of the plurality of locations (e.g., points 450(x, y), 450(x+1, y), 450(x+2, y), . . . 450(x+j, y)) along the entire width “W” of the glass ribbon 103 based on the corresponding sensed temperature of the glass ribbon 103 at the plurality of locations (e.g., points 450(x, y), 450(x+1, y), 450(x+2, y), . . . 450(x+j, y)) along the first path 460 and the corresponding sensed change in temperature (dT/dy) of the glass ribbon 103 at the plurality of locations (e.g., points 450(x, y); 450(x, y+1), 450(x, y+2), . . . 450(x, y+k); 450(x, y−1), 450(x, y−2), . . . 450(x, y−k); 450(x+1, y), 450(x+2, y), . . . 450(x+j, y); 450(x+j, y+k); and 450(x+j, y−k) along the plurality of second paths 465i, 465ii, 465iii, . . . 465i+n.

It is to be understood that a resolution of the thermal sensor 161, 163 can define, at least in part, the number of points (e.g., pixels) at which a temperature of the glass ribbon 103 can be sensed. For example, a thermal sensor 161, 163 including a high level of resolution can sense (e.g., image) a correspondingly high number of points (e.g., pixels), each of which can correspond to the sensed temperature of the glass ribbon 103 at a particular spatial location (e.g., coordinate location) on the glass ribbon 103. Accordingly, the present disclosure is to be understood to encompass thermal sensors 161, 163 of any resolution. Further, it is to be understood that, in some embodiments, a higher resolution thermal sensor 161, 163 (although able to provide higher precision estimation) may require larger computing power to analyze and process the corresponding sensed temperature data. Thus, in some embodiments, a balance between resolution of the thermal sensor 161, 163 and an associated efficiency and speed of computation may be implemented, without departing from the scope of the disclosure, and without limiting the scope of the disclosure. Moreover, it is to be understood that the pixels of the thermal sensor 161, 163 can be arranged in any pattern (e.g., a linear pattern, as illustrated) as well as non-linear patterns.

In another embodiment, the temperature can include a one-dimensional thermal profile, a two-dimensional thermal profile, or a three-dimensional thermal profile. For instance, the temperature can include a one-dimensional thermal profile representing a thermal profile of the edge portions 223a, 223b of the glass ribbon 103 and/or the central portion 219 of the glass ribbon 103 at one or more locations (e.g., pixels) along a first path 460. In other embodiments, the temperature can include a two-dimensional thermal profile representing a thermal profile of the edge portions 223a, 223b of the glass ribbon 103 and/or the central portion 219 of the glass ribbon 103 at a plurality of locations (e.g., pixels) along the first path 460 and along a plurality of second paths 465i, 465ii, 465iii, . . . 465i+n. In still other embodiments, the temperature can include a three-dimensional thermal profile representing a thermal profile of the edge portions 223a, 223b of the glass ribbon 103 and/or the central portion 219 of the glass ribbon 103 at a plurality of locations (e.g., pixels) along the first path 460, the plurality of second paths 465i, 465ii, 465iii, . . . 465i+n, and at a plurality of locations (e.g., pixels) corresponding to a through-thickness temperature profile of the glass ribbon 103 along a third path 470. In some embodiments, the through-thickness temperature of the glass ribbon 103 can be constant (e.g., can be assumed to be constant), and a one-dimensional thermal profile or a two-dimensional thermal profile of the edge portions 223a, 223b of the glass ribbon 103 and/or the central portion 219 of the glass ribbon 103 can be used to accurately represent the thermal profile of the glass ribbon 103.

For instance, as shown in FIG. 4, the thermal sensor 163 can capture at least one of a plurality of thermal images that provide two-dimensional thermal profiles 405, 409 of the glass ribbon 103. An image scale 417 can be used to assign a temperature profile to the thermal profiles 405, 409. The two-dimensional thermal profile 405 can represent a thermal profile of an area 229a of the edge portion 223b within a sensing window (e.g., sensing window 235 corresponding to the thermal sensor 161 in FIG. 2) and/or a two-dimensional thermal profile 409 representing a thermal profile of an area 213a of the central portion 219 of the glass ribbon 103 within the sensing window (e.g., sensing window 235 corresponding to the thermal sensor 161 in FIG. 2). The two-dimensional thermal profile 405 can include a width that may be identical to or correspond to a width 403 of the edge portion 223b of the glass ribbon 103. The two-dimensional thermal profile 405 can also include a height 413 that may be identical to or correspond to the height 413 of the sensing window (e.g., sensing window 235 corresponding to the thermal sensor 161 in FIG. 2). Furthermore, the two-dimensional thermal profile 409 can include a width 415 that may be identical to or correspond to a portion of the width 415 of the sensing window (e.g., sensing window 235 corresponding to the thermal sensor 161 in FIG. 2). Likewise, the two-dimensional thermal profile 409 can also include a height 413 that may be identical to or correspond to the height 413 of the sensing window (e.g., sensing window 235 corresponding to the thermal sensor 161 in FIG. 2), as discussed above.

As shown in FIG. 2, the sensing window 235 can be arranged to extend off the outer edge portion 223a, 223b of the glass ribbon 103. Although not required, extending the sensing window 235 off the outer edge portion 223a, 223b of the glass ribbon 103 can ensure that the entire edge portion 223a, 223b of the glass ribbon 103 can be sensed by the thermal sensor 161, 163. As shown in FIG. 4, a corresponding thermal profile 411 of the overextended portion of the viewing window 235 can be easily identified as the image of the ambient environment laterally adjacent the outer edge portion 223a, 223b of the glass ribbon 103 and can help determine the outer peripheral boundary of the outer edge portion 223a, 223b of the glass ribbon 103.

As shown, a first thermal sensor 161 can be designed to simultaneously image (e.g., thermally image) both an area of the central portion 219 of the glass ribbon 103 and an area of at least one of the edge portions 223a, 223b of the glass ribbon 103. For instance, as shown in FIG. 1, the first thermal sensor 161 can have a sensing window (e.g., sensing window 235 in FIG. 2) that can simultaneously capture an image of the first edge portion 223a of the glass ribbon 103 and an area of the central portion 219 of the glass ribbon 103. Likewise, as illustrated in FIG. 4, a second thermal sensor 163, if provided, can have a similar or identical sensing window 235 that can capture another area of the central portion 219 of the glass ribbon 103 and an area of the second edge portion 223b of the glass ribbon 103. Although not shown, separate thermal sensors may be provided for each of the central portions 219 of the glass ribbon 103 and at least one of the edge portions 223a, 223b of the glass ribbon 103. For instance, one thermal sensor may be provided that only senses a temperature of the central portion 219 of the glass ribbon 103 while another thermal sensor may be provided that only senses a temperature of one of the edge portions 223a, 223b of the glass ribbon 103.

Furthermore, although two thermal sensors 161, 163 are shown, any number of thermal sensors may be used. For example, in some embodiments, a single thermal sensor can simplify the process, help fully capture the image of the edge portions 223a, 223b of the glass ribbon 103, and can also provide seamless imaging transition between the edge portions 223a, 223b of the glass ribbon 103 and the central portion 219 of the glass ribbon 103. For instance, a single thermal sensor can be provided with a window that extends across the entire width “W” of the glass ribbon 103. In another embodiment, a single thermal sensor can be provided to only determine a temperature of one of the edge portions 223a, 223b of the glass ribbon 103 with the results of the single sensor being used to estimate the thickness 401 of both edge portions 223a, 223b of the glass ribbon 103. Providing a single thermal sensor may reduce costs and may be particularly feasible in applications where the thickness profiles of the edge portions 223a, 223b of the glass ribbon 103 are expected to be substantially identical to one another. However, to provide higher accuracy and to account for process variations, there may be a benefit in imaging each edge portion 223a, 223b of the glass ribbon 103 to sense a temperature or a plurality of temperatures of each edge portion 223a, 223b of the glass ribbon 103 with one or more thermal sensors.

As shown, each edge portion 223a, 223b of the glass ribbon 103 and an adjacent area of the central portion 219 of the glass ribbon 103 may be thermally imaged. Indeed, the first thermal sensor 161 can sense a temperature of the first edge portion 223a of the two opposed edge portions 223a, 223b of the glass ribbon 103 and a temperature of a first location of the central portion 219 of the glass ribbon 103. In the illustrated embodiment, the first location of the central portion 219 of the glass ribbon 103 can be located immediately adjacent the first opposed edge portion 223a of the glass ribbon 103 and may even include a common boundary with the first opposed edge portion 223a of the glass ribbon 103. Likewise, the second thermal sensor 163 may be provided to sense a temperature of the second edge portion 223b of the two opposed edge portions 223a, 223b of the glass ribbon 103 and a temperature of a second location of the central portion 219 of the glass ribbon 103. In the illustrated embodiment, the second location of the central portion 219 of the glass ribbon 103 can be located immediately adjacent the second opposed edge portion 223b of the glass ribbon 103 and may even include a common boundary with the second opposed edge portion 223b of the glass ribbon 103.

In further embodiments, one thermal sensor, two thermal sensors, or any number of thermal sensors can be provided with corresponding windows that either alone or together extend across the entire width “W” of the glass ribbon 103 to image each edge portion 223a, 223b of the glass ribbon 103 to sense a temperature or a plurality of temperatures of each edge portion 223a, 223b of the glass ribbon 103 and to image the central portion 219 of the glass ribbon 103 to sense a temperature or a plurality of temperatures of the central portion 219 of the glass ribbon 103. The thermal sensors 161, 163 can image the glass ribbon 103 and sense a plurality of temperatures of the glass ribbon 103 on a relatively fast basis (e.g., quick cycle times). In some embodiments, the thermal sensors 161, 163 can image the glass ribbon 103 and sense a plurality of temperatures of the glass ribbon 103 faster than, for example, the thickness sensor 159, 160 can measure the same number of thicknesses of the glass ribbon 103. Accordingly, in some embodiments, the thermal sensors 161, 163 can provide faster processing times and allow for faster response and adjustment of the glass former 102 based on the sensed temperatures and the corresponding sensed thicknesses of the glass ribbon 103, eliminating in some embodiments, measurement delay. Thus, some embodiments of the present disclosure permit continuous and timely feedback analysis of the glass manufacturing apparatus 101 to control and maintain, among other features, a consistent flow rate of molten material 121 and tighter control to achieve low average thickness variation of the glass ribbon 103.

Referring back to FIG. 1, the glass manufacturing apparatus 101 can also include a processor 165 programmed to estimate a thickness of the glass ribbon 103 based on the sensed temperature from the thermal sensor. For example, the processor 165 can be programmed to estimate the thickness 401 of at least one of the two opposed edge portions 223a, 223b of the glass ribbon 103 based on a sensed temperature of at least one of the two opposed edge portions 223a, 223b of the glass ribbon 103 from the thermal sensor 161, 163 as well as a thickness 217 of the central portion 219 of the glass ribbon 103 based on a sensed temperature of the central portion 219 of the glass ribbon 103 from the thermal sensor 161, 163. Accordingly, in some embodiments, the processor 165 can be programmed to estimate a thickness of the glass ribbon 103 across an entire width “W” of the glass ribbon 103 based on one or more sensed temperatures of the glass ribbon 103 from the thermal sensor 161, 163.

In another embodiment, the thermal sensor 161, 163 can be oriented to sense a corresponding temperature of the glass ribbon 103 at a plurality of locations (e.g., points 450(x, y), 450(x+1, y), 450(x+2, y), . . . 450(x+j, y)) along the first path 460 transverse to the draw direction 207, and the processor 165 can be programmed to estimate a corresponding thickness of the glass ribbon 103 at each of the plurality of locations (e.g., points 450(x, y), 450(x+1, y), 450(x+2, y), . . . 450(x+j, y)) based on the corresponding sensed temperature from the thermal sensor 161, 163. As shown in FIG. 4, the first path 460 can extend laterally along a width 415 of the central portion 219 of the glass ribbon 103 and along a width 403 of the end portion 223b of the glass ribbon 103, and the processor 165 can be programmed to estimate a corresponding thickness (e.g., thickness 217, thickness 401) of the glass ribbon 103 at each of the plurality of locations (e.g., points 450(x, y), 450(x+1, y), 450(x+2, y), . . . 450(x+j, y)) along the width 415 of the central portion 219 of the glass ribbon 103 and along the width 403 of the end portion 223b of the glass ribbon 103 based on the corresponding sensed temperature from the thermal sensor 161, 163. In other embodiments, the first path 460 can extend laterally along an entire width “W” of the glass ribbon 103, and the processor 165 can be programmed to estimate a corresponding thickness (e.g., thickness 217, thickness 401) of the glass ribbon 103 at each of the plurality of locations (e.g., points 450(x, y), 450(x+1, y), 450(x+2, y), . . . 450(x+j, y)) along the entire width “W” of the glass ribbon 103 based on the corresponding sensed temperature from the thermal sensor 161, 163.

In further embodiments, the thermal sensor 161, 163 can be oriented to sense a temperature of at least one of the two opposed edge portions 223a, 223b of the glass ribbon 103, and the processor 165 can be programmed to estimate a thickness 401 of at least one of the two opposed edge portions 223a, 223b of the glass ribbon 103 based on the sensed temperature of the at least one of the two opposed edge portions 223a, 223b of the glass ribbon 103. In another embodiment, the thermal sensor 161, 163 can also be oriented to sense a temperature of the central portion 219 of the glass ribbon 103, and the processor 165 can be programmed to estimate a thickness 401 of at least one of the two opposed edge portions 223a, 223b of the glass ribbon 103 based on the sensed temperature of the at least one of the two opposed edge portions 223a, 223b of the glass ribbon 103, the sensed temperature of the central portion 219 of the glass ribbon, and the sensed thickness 217 of the central portion 219 of the glass ribbon 103 from the thickness sensor 159.

The temperature (T) of the glass ribbon 103 can be sensed at any elevation along the draw direction 207 of the glass ribbon 103. For example, because the glass ribbon 103 can be in an elastic state where a thickness profile of the glass ribbon 103 is set, a thickness of a particular point on the glass ribbon 103 should not change as the glass ribbon 103 is drawn in the draw direction 207. Accordingly, the thickness sensor 160 can be placed downstream from the thermal sensors 161, 163 so as to not interfere with the thermal sensors 161, 163. The thickness sensor 160 can, therefore, sense a thickness 217 of the central portion 219 of the glass ribbon 103, and such sensed thickness can be used to calibrate the convective heat transfer coefficient (h) of the glass ribbon 103, in some embodiments. Such calibration of the convective heat transfer coefficient (h) can occur at least one of once, multiple times (e.g., periodically), and continuously during the glass manufacturing process. Additionally, in embodiments where the thermal sensors 161, 163 sense a temperature of the edge portions 223a, 223b of the glass ribbon 103, the thickness sensor 159 can be positioned at the same or similar elevation as the thermal sensors 161, 163 to sense the thickness 217 of the central portion 219 of the glass ribbon 103. As shown in FIG. 2, the sensed thickness 217 of the central portion 219 of the glass ribbon 103 can be measured at the location 233 (marked by the “+” shown in FIG. 2) with a laser beam 231 from the thickness sensor 159 that may be laterally adjacent to and within the sensing window 235. In further embodiments, the sensed thickness 217 of the central portion 219 of the glass ribbon 103 can be measured at the location 234 (marked by the “+” shown in FIG. 2) with a laser beam 232 from the thickness sensor 160 that may be positioned downstream from the thermal sensor 161, 163.

In one embodiment, the processor 165 can be programmed to estimate the thickness (t) of the glass ribbon 103 as a function of the relationship:

$$\frac{t}{2} v ρ {C}_{p} ( \frac{d}{dy} T ) = - h ( T - {T}_{a} ) + ɛσ ( {T}^{4} - {T}_{a}^{4} ) \qquad Relationship 1$$

where, v represents a velocity of the glass ribbon 103 along the draw direction 207; ρ represents a density of a material of the glass ribbon 103; Cₚ represents a heat capacity of the material of the glass ribbon 103; y represents a coordinate in the draw direction 207; T represents the sensed temperature of the glass ribbon 103 from the thermal sensor 161, 163 (e.g., the sensed temperature of the at least one of the two opposed edge portions 223a, 223b of the glass ribbon 103 from the thermal sensor 161, 163); h represents a convective heat transfer coefficient of the glass ribbon 103; Tₐ represents a temperature of an ambient and radiative environment of the glass ribbon 103; ε represents an emissivity of the glass ribbon 103; and σ represents the Stefan-Boltzmann constant.

In another embodiment, the convective heat transfer coefficient (h) of the glass ribbon 103 can be estimated as a function of the relationship:

$$h = \frac{ɛσ ( {T}^{4} - {T}_{a}^{4} ) - \frac{τ}{2} v ρ {C}_{p} ( \frac{d}{dy} T )}{( T - {T}_{a} )} \qquad Relationship 2$$

where, τ represents the sensed thickness 217 of the central portion 219 of the glass ribbon 103 from the thickness sensor 160;

In another embodiment, the processor 165 can be programmed to estimate the thickness (t) of the glass ribbon 103 as a function of the relationship:

$$\frac{t}{2} v ρ {C}_{p} ( \frac{d}{dy} T ) = - h ( T - {T}_{a} ) + ɛσ ( {T}^{4} - {T}_{a}^{4} ) + k \qquad Relationship 3$$

where, v represents a velocity of the glass ribbon 103 along the draw direction 207; ρ represents a density of a material of the glass ribbon 103; Cₚ represents a heat capacity of the material of the glass ribbon 103; y represents a coordinate in the draw direction 207; T represents the sensed temperature of the glass ribbon 103 from the thermal sensor 161, 163 (e.g., the sensed temperature of the at least one of the two opposed edge portions 223a, 223b of the glass ribbon 103 from the thermal sensor 161, 163); h represents a convective heat transfer coefficient of the glass ribbon 103; Tₐ represents a temperature of an ambient and radiative environment of the glass ribbon 103; ε represents an emissivity of the glass ribbon 103; σ represents the Stefan-Boltzmann constant; k represents a corrective term of the convective heat transfer coefficient.

In another embodiment, the convective heat transfer coefficient (h) of the glass ribbon 103 can be estimated as a function of the relationship:

$$h = \frac{ɛσ ( {T}^{4} - {T}_{a}^{4} ) + k - \frac{τ}{2} v ρ {C}_{p} ( \frac{d}{dy} T )}{( T - {T}_{a} )} \qquad Relationship 4$$

where, τ represents the sensed thickness 217 of the central portion 219 of the glass ribbon 103 from the thickness sensor 160.

In another embodiment, the corrective term (k) of the convective heat transfer coefficient can be estimated to be within a range of:

$$0 \leq k \leq \frac{c}{2} ( τ \frac{{d}^{2} T}{{dx}^{2}} + \frac{d τ}{dx} \frac{dT}{dx} ) \qquad Relationship 5$$

where, τ represents the sensed thickness 217 of the central portion 219 of the glass ribbon 103 from the thickness sensor 160; T represents the sensed temperature of the glass ribbon 103 from the thermal sensor 161, 163 (e.g., the sensed temperature of the at least one of the two opposed edge portions 223a, 223b of the glass ribbon 103 from the thermal sensor 161, 163); c represents a thermal conductivity coefficient of the material of the glass ribbon 103; x represents a coordinate transverse to the draw direction 207.

In other embodiments, any one or more of the parameters of Relationships 1-5 can be known (e.g., predetermined) numerical values, obtained from tables, known material properties, data obtained from online (e.g., during manufacture of the glass ribbon 103) and/or offline (e.g., laboratory) experimental analysis, data determined by theoretical analysis, data based on past data trends, data estimated assuming nominal parameters, and data obtained by any other suitable manner by which to determine any one or more of the variables of Relationship 1. In other embodiments, any one or more of the parameters can be constant, and thus assumed to be independent of other factors (e.g., time, temperature, spatial location, etc.). In some embodiments, any one or more of the parameters can be variable, and thus assumed to be dependent on other factors (e.g., time, temperature, spatial location, etc.). In still other embodiments, any one or more of the parameters can be measured from the glass manufacturing apparatus 101 (e.g., in real-time). Moreover, any one or more of the parameters can be measured at a particular spatial location (e.g., a coordinate) on the glass ribbon 103. Accordingly, in some embodiments, the thickness (t) of the glass ribbon 103 can be estimated with, for example, Relationship 1 at a particular spatial location and/or at a particular moment or period in time, where any one or more of the parameters of Relationship 1 can be discretized to correspond to the value representative of that parameter at the particular spatial location (e.g., a coordinate) on the glass ribbon 103 where the temperature (T) of the glass ribbon 103 is sensed by the thermal sensor 161, 163 at the particular moment or period in time. In embodiments where a plurality of temperatures (T) are sensed on the glass ribbon 103, a corresponding plurality of thicknesses (t) can be estimated with Relationship 1, and any one or more parameters of Relationship 1 can be discretized to correspond to the value representative of that parameter at the particular spatial location (e.g., a coordinate) on the glass ribbon 103 where the temperature (T) of the glass ribbon 103 is sensed by the thermal sensor 161, 163 at any one or more particular moments or periods in time.

In one embodiment, the estimated thickness (t) of only the first edge portion 223a or only the second edge portion 223b may be calculated. In such embodiments, the calculated estimated thickness can be used for both edge portions 223a, 223b of the glass ribbon 103 if it is assumed that both edge portions 223a, 223b of the glass ribbon 103 are identical. Alternatively, separate parameters unique to each second portion 223b may be used to solve the relationship twice, i.e., one relationship for each edge portion 223a, 223b. Solving a single relationship for one of the edge portions may be beneficial in applications where the edge portions 223a, 223b of the glass ribbon 103 are similar or substantially identical to one another. Solving the single relationship can have the benefit of reducing complexity while still providing sufficient improvement in edge thickness estimation. Solving two unique relationships (i.e., one for each edge portion 223a, 223b) may be beneficial in applications where edge portions 223a, 223b of the glass ribbon 103 may be substantially different from one another and/or in applications where edge portion thickness may change over time. Still furthermore, solving two unique relationships may provide further accuracy in estimating the individual thicknesses of each edge portion 223a, 223b of the glass ribbon 103.

As mentioned above, (v) represents the velocity of the glass ribbon 103, and can include a velocity of at least one of the two opposed edge portions 223a, 223b of the glass ribbon 103 along the draw direction 207 of the glass ribbon 103 and/or a velocity of the central portion 219 of the glass ribbon 103. For instance, if estimating the thickness of the first edge portion 223a, (v) may be the velocity of the first edge portion 223a in the draw direction 207. In some embodiments, a single velocity value corresponding, generally, to the velocity of the glass ribbon 103 may be assumed. The velocity of the glass ribbon 103 can be determined by a sensor, for example an optical sensor that monitors the velocity of the glass ribbon 103. In another embodiment, an idler roller may be used, wherein an outer cylindrical surface with known diameter engages the outer surface (e.g., knurled surface 229) of the edge portion 223a, 223b of the glass ribbon 103. A sensor can then be used to monitor the rotational rate of the cylindrical surface to calculate the velocity of the edge portion 223a, 223b of the glass ribbon 103. In one embodiment, the velocity of each edge portion 223a, 223b may be calculated by monitoring the rotational rate of the edge rolls 221 or the pull rolls 153 that each may have a known outer diameter. While the velocity of the first edge portion 223a may be directly monitored or determined, a velocity of another location of the glass ribbon 103 may alternatively be monitored or determined and assumed to be the velocity of the first edge portion 223a. This assumption is particularly applicable if all portions of the glass ribbon travel at the same velocity in the draw direction 207 at the elevation along the draw plane 211 where the measurements are taken. Still further heat capacity (Cᵣ), density (ρ) and emissivity (ε) can all be determined based on the material properties of the glass ribbon 103. The ambient air temperature (Tₐ) can be determined, in some embodiments, based on a temperature sensor positioned adjacent the edge portion of the glass ribbon 103.

The corrective term (k) can be optional. Indeed, in some embodiments, the corrective term (k) may equal zero or may not exist in the relationship. In further embodiments, (k) can be within the range up to the illustrated calculated value above. When calculating the upper range of (k), the thermal conductivity (c) can be obtained based on the material properties of the glass ribbon 103. Moreover, as also mentioned above, (x) is a coordinate (See the X axis in FIG. 2) that is perpendicular to the draw direction 207 and (T) is the sensed temperature from the at least one thermal sensor 161, 163 at the central portion 219 of the glass ribbon 103. As such, the temperature gradient in the X-direction can be determined from the temperature profile 409 and used as the term (dT/dx) when determining the upper range of (k) in the formula above.

In some embodiments, the parameters in the above relationships can be dependent on the properties of the glass material of the glass ribbon 103 or can be easily measured as discussed above. However, one variable that is not easily determined is the convective heat transfer coefficient (h) of the glass ribbon 103, for example, between the two opposed edge portions 223a, 223b of the glass ribbon 103 and the ambient air and radiative environment at the opposed edge portions 223a, 223b of the glass ribbon 103. It has been determined that convective heat transfer coefficient (h) corresponding to the two opposed edge portions can closely correspond to the heat transfer coefficient (h) corresponding to the central portion 219 of the glass ribbon 103 positioned laterally adjacent to the opposed edge portions 223a, 223b of the glass ribbon 103, in some embodiments. As the thickness 217 of the central portion 219 of the glass ribbon 103 can be determined with the thickness sensor 159, Relationship 1, for example, can be solved for the heat transfer coefficient (h) of the central portion 219 of the glass ribbon 103 as shown by Relationship 2. Then, the heat transfer coefficient (h) of the central portion 219 of the glass ribbon 103 can be used as the heat transfer coefficient (h) of the edge portions 223a, 223b of the glass ribbon 103 when calculating the thickness of the edge portions 223a, 223b of the glass ribbon 103 using Relationship (l) as shown above. Moreover, in some embodiments, the corrective term (k) in one relationship may be different than the corrective term (k) in another relationship.

As further illustrated in FIG. 1, in some embodiments, the glass manufacturing apparatus 101 can also include an optional temperature adjustment device 167a, 167b, 167c (e.g., heater, cooler) to adjust a temperature of a quantity of molten material 121 of the glass manufacturing apparatus 101. In some embodiments, the temperature adjustment device 167a, 167b, 167c can include the schematically illustrated heater 167a, 167b, 167c. The heater 167a, 167b, 167c can include resistance heaters, radiative heaters, and other heating devices. As shown, the heater 167a, 167b, 167c may be provided at various alternative locations upstream from the root 209 of the forming wedge 201. For example, as illustrated, a first heater 167a can be designed to heat the quantity of molten material 121 and thereby raise the temperature of the quantity of molten material 121 within the third connecting conduit 137. In addition or alternatively, a second heater 167b can be designed to heat the quantity of molten material 121 and thereby raise the temperature of the quantity of molten material 121 within the delivery vessel 133. In addition or alternatively, in still another embodiment, a third heater 167c may be designed to heat the quantity of molten material 121 and thereby raise the temperature of the quantity of molten material 121 within the delivery pipe 139. Adjusting the temperature of the quantity of molten material 121 can result in a change in viscosity and therefore a change in flow rate of the molten material 121. For instance, the temperature of the molten material 121 may be raised to reduce the viscosity and thereby increase the flow rate of the molten material 121. In further embodiments, the temperature of molten material 121 may be lowered to increase the viscosity of the molten material 121 and thereby decrease the flow rate of the molten material 121.

The glass manufacturing apparatus 101 can still further include a controller 169 to operate the any one or more of the temperature adjustment device(s) 167a, 167b, 167c to adjust the temperature of the molten material 121 based on, for example, the estimated thickness 401 of the at least one of the two opposed edge portions 223a, 223b of the glass ribbon 103 as estimated by the processor 165. Indeed, based on the estimated thickness 401 of the at least one of the two opposed edge portions 223a, 223b of the glass ribbon 103 and other factors discussed in this disclosure, the estimated flow rate 171 of the glass ribbon 103 can be determined by the processor 165. The controller 169 can compare the estimated flow rate 171 of the molten glass 121 with a target flow rate 173 entered into the controller 169. If the estimated flow rate 171 of the molten glass 121 is less than the target flow rate 173, the controller 169 can send a command to the temperature adjustment device(s) 167a, 167b, 167c to increase the temperature and thereby increase the actual flow rate of the quantity of molten glass 121. If the estimated flow rate 171 is greater than the target flow rate 173, the controller 169 can alternatively avoid heating with the temperature adjustment device(s) 167a, 167b, 167c, heat at a lower rate, and/or send a command to one or more cooling devices (e.g., fans, cooling coils, etc.) to cool the quantity of molten glass 121 and thereby reduce the flow rate of the molten glass 121.

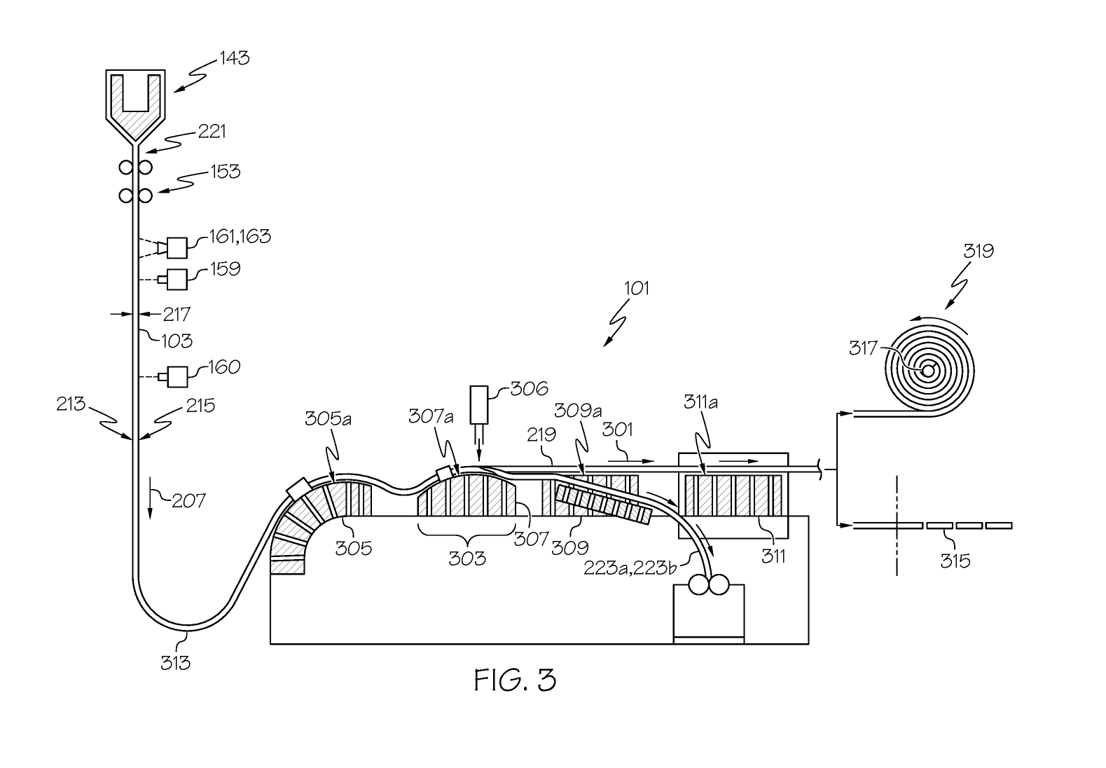

Optionally, as shown in FIG. 3, the glass manufacturing apparatus 101 may include a processing zone to process the glass ribbon 103. For example, the processing zone may include a grinding zone and/or finishing zone to machine the edges of the glass ribbon 103. In further embodiments, the processing zone may include a cleaning zone to remove contaminants from the edges and/or major surfaces of the glass ribbon 103. In additional embodiments, the processing station may add one or more layers of lamination or coatings to the glass ribbon 103. In still further embodiments, the processing station may chemically treat the glass ribbon 103 and/or add features (e.g., electronic components) to the glass ribbon 103.

In further embodiments, the processing zone, if provided, can include a cutting zone to separate the glass ribbon 103 along a longitudinal axis of the glass ribbon 103 in a direction 301 of the glass ribbon conveyance path. For instance, as shown in FIG. 3, a cutting zone 303 may be used to trim one or both of the two opposed outer edge portions 223a, 223b from the central portion 219 of the glass ribbon 103 with a glass separator 306. In one embodiment, the schematically-illustrated glass separator 306 can optionally include two lasers to facilitate separation of the corresponding two opposed outer edge portions 223a, 223b from the central portion 219 of the glass ribbon 103.

The glass manufacturing apparatus 101 can include a plurality of fluid supports, for example the illustrated air bearings 305, 307, 309, 311, to support a weight of the glass ribbon 103 on an air cushion. Although air bearings are illustrated, other fluid bearings may be provided including liquid bearings, gas bearings (e.g., inert gas, other gases). The fluid supports, for example the illustrated air bearings 305, 307, 309, 311, can effectively support the glass ribbon 103 (e.g., while conveying the glass ribbon 103) on an air cushion while inhibiting (e.g., preventing) mechanical contact between the corresponding major surface 213 of the glass ribbon 103 and the underlying solid air bearing that may otherwise scratch and/or damage the pristine major surface 213 of the glass ribbon 103. As such, rather than mechanically contacting the pristine major surface 213 of the glass ribbon 103, the fluid support members (e.g., air bearings 305, 307, 309, 311) may non-mechanically support the glass ribbon 103 with a cushion of fluid, for example liquid (e.g., water, etc.) or gas (e.g., air, inert gas, etc.), providing fluid support of the glass ribbon 103 while protecting the pristine major surfaces 213 of the glass ribbon 103.

In still further embodiments, support surfaces 305a, 307a, 309a, 311a of the air bearings 305, 307, 309, 311 may be shaped to facilitate conveyance of the glass ribbon 103 along the conveyance path. For instance, in some embodiments, the support members may include substantially planar support surfaces to facilitate conveyance of the glass ribbon 103 along a substantially straight path. Indeed, the illustrated support surfaces 309a, 311a of the respective air bearings 309, 311 may have a substantially straight profile along a planar support surface of the air bearings to promote a planar orientation of the glass ribbon 103 along a substantially straight path while being supported by the air bearings 309, 311.

In further embodiments, the support members may include substantially curved support surfaces to facilitate conveyance of the glass ribbon 103 along a substantially arcuate path. Indeed, the illustrated support surfaces 305a, 307a of the respective air bearings 305, 307 may have a substantially curved support surface to promote a curved orientation of the glass ribbon 103 along a substantially arcuate path while being supported by the air bearings 305, 307. Providing the air bearing 305 with the curved support surface 305a can be beneficial to reduce stress as the glass ribbon 103 transitions from the draw direction 207 and/or from the illustrated free loop 313 to the generally horizontal conveyance direction 301. In further embodiments, the curved support surface may be beneficial to increase local rigidity of the flexible glass ribbon 103 at predetermined processing zones. For instance, providing the air bearing 307 with the curved support surface 307a can be beneficial to help increase the local rigidity of the glass ribbon 103 to stabilize the glass ribbon 103 being cut within the cutting zone 303.

The glass manufacturing apparatus 101 may further convey the glass ribbon 103 downstream to a subsequent processing zone or to store the glass ribbon 103. For instance, in one embodiment, the glass ribbon 103 may be processed by a glass separator into a plurality of glass sheets 315 that are separated from the glass ribbon 103. In another embodiment, the glass manufacturing apparatus 101 may include a storage spool 317 to wind the glass ribbon 103 into a spool 319 of glass ribbon 103.

A method of manufacturing glass can include forming the glass ribbon 103 from the quantity of molten material 121, as discussed above, sensing a temperature of the glass ribbon 103 (e.g., with one or more thermal sensors 161, 163), as discussed above, and estimating a thickness of the glass ribbon 103 (e.g., with the processor 165) based on the sensed temperature of the glass ribbon 103, as discussed above. In another embodiment, the method can include the step of operating a glass former 102 (e.g., any one or more of the components of the glass manufacturing apparatus 101) based on the estimated thickness of the glass ribbon 103. In another embodiment, the method can include the step of adjusting a flow rate of the quantity of molten material 121 based on the estimated thickness of the glass ribbon 103. In another embodiment, the method can include the step of adjusting a temperature of the molten material 121 based on the estimated thickness of the glass ribbon 103. In another embodiment, the method can include the step of adjusting a pull roll assembly 151a, 151b based on the estimated thickness of the glass ribbon 103.

Once drawn, the glass ribbon 103 can include the two opposed edge portions 223a, 223b of the glass ribbon 103 and the central portion 219 of the glass ribbon 103 disposed between the two opposed edge portions 223a, 223b of the glass ribbon 103. The method can further include the step of sensing a temperature of at least one of the two opposed edge portions 223a, 223b of the glass ribbon 103, sensing a thickness 217 of the central portion 219 of the glass ribbon 103, and estimating a thickness (t) of at least one of the two opposed edge portions 223a, 223b of the glass ribbon 103 based on the sensed temperature of the at least one of the two opposed edge portions 223a, 223b of the glass ribbon 103. In another embodiment, the method can include the step of sensing a temperature of the central portion 219 of the glass ribbon 103, the step of estimating the thickness (t) of at least one of the two opposed edge portions 223a, 223b of the glass ribbon 103 can include estimating a thickness of at least one of the two opposed edge portions 223a, 223b of the glass ribbon 103 based on the sensed temperature of the at least one of the two opposed edge portions 223a, 223b of the glass ribbon 103, the sensed temperature of the central portion 219 of the glass ribbon 103, and the sensed thickness 217 of the central portion 219 of the glass ribbon 103.

In another embodiment, the method can include the step of operating a glass former 102 (e.g., any one or more of the components of the glass manufacturing apparatus 101) based on the estimated thickness of at least one of the two opposed edge portions 223a, 223b of the glass ribbon 103. In another embodiment, the method can include the step of adjusting a flow rate of the quantity of molten material 121 based on the estimated thickness of the at least one of the two opposed edge portions 223a, 223b of the glass ribbon 103. In another embodiment, the method can include the step of adjusting a temperature of the molten material 121 based on the estimated thickness of the at least one of the two opposed edge portions 223a, 223b of the glass ribbon 103. In another embodiment, the method can include the step of adjusting a pull roll assembly 151a, 151b based on the estimated thickness of the at least one of the two opposed edge portions 223a, 223b of the glass ribbon 103

Any of the embodiments of the disclosure can further include the step of adjusting a flow rate (e.g., volumetric flow rate or mass flow rate) of the quantity of molten material 121 based on the estimated thickness 401 of the at least one of the two opposed edge portions 223a, 223b of the glass ribbon 103. If the mass flow rate is used, the total mass flow of the molten glass forming the glass ribbon 103 can be estimated by calculating overall volumetric flow rate (Vₒᵥₑᵣₐₗₗ) of the molten glass (calculated as discussed above) multiplied by the density of the molten glass. The flow rate (either mass or volumetric flow rate) can then be adjusted after calculating the overall flow rate, for example, by adjusting a temperature of the molten material 121 as discussed above. Indeed, in some embodiments, the flow rate may be adjusted without directly calculating the thickness 401 of the at least one edge portion 223a, 223b of the glass ribbon 103. Rather than separately calculate the thickness, for example, Relationship 1 and Relationship 2 may be inserted directly into a program that adjusts the flow rate based on Relationship 1 and Relationship 2 without separately designating the thickness of the edge portion of the glass ribbon although the thickness is inherently considered in the program to adjust the flow rate of the molten material. For example, the thickness relationship can be inserted directly into the relationship that determines the area (A_{edge1}, A_{edge2}) discussed above without independently determining the thickness. However, thickness monitoring may be desired in some applications. As such, even in applications designed primarily to adjust the flow rate of the molten glass, there may still be a desire to also provide an estimate of the thickness of the edge portion 223a, 223b of the glass ribbon 103 as an output of the method to consider other attributes of the glass ribbon 103.

As shown in FIG. 3, the method can further include the steps of processing the glass ribbon 103 as discussed above. In addition or alternatively, the glass ribbon 103 may be cut into glass sheets 315 or wound into the spool 319 of glass ribbon 103. FIG. 1 schematically illustrates the method of using the processor 165 in one embodiment of the present disclosure to estimate flow rate 171 of the molten material 121 used to produce the glass ribbon 103. A first sensed temperature 161a from the first thermal sensor 161 and a second sensed temperature 163a from the second thermal sensor 163 can be input into a processing routine 175, for example, that may create a matrix of temperature data from infrared thermal image(s). Furthermore, the sensed thickness 217 of the central portion 219 of the glass ribbon 103, from the thickness sensor 159 for example, can be input at 177. As indicated by arrows 179 and 180, the sensed thickness 217 and the temperature data 180 can be input into a routine 181 that uses the above relationships to estimate the thickness 401 of the edge portions 223a, 223b of the glass ribbon 103. The estimated thickness 401 of the edge portions 223a, 223b of the glass ribbon 103, together with other information (e.g., width 403 of the edge portions 223a, 223b of the glass ribbon 103 and speed of the glass ribbon 103) can then be used in another routine 183 to calculate the volumetric flow rates (V_{edge1}, V_{edge2}) or, with a known glass melt density, the mass flow rates of the edge portions 223a, 223b of the glass ribbon 103. As further indicated by arrow 185, the sensed thickness 217 of the central portion 219 of the glass ribbon 103 can also be used together with further information (e.g., width 157 of the central portion 219 of the glass ribbon 103 and speed of the glass ribbon 103) to calculate the volumetric flow rate (V_{central}) or, with a known glass melt density, the mass flow rate of the central portion 219 of the glass ribbon 103. As indicated by the summation junction 189, the flow rates of the edge portions 223a, 223b of the glass ribbon 103 may be added to the flow rate of the central portion 219 of the glass ribbon 103 to arrive at the estimated flow rate 171 of the molten material 121 forming the glass ribbon 103.

Embodiments and the functional operations described herein can be implemented in digital electronic circuitry, or in computer software, firmware, or hardware, including the structures disclosed in this specification and their structural equivalents, or in combinations of one or more of them. Embodiments described herein can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine readable storage substrate, a memory device, or a combination of one or more of them.

The term “processor” or “controller” can encompass all apparatus, devices, and machines for processing data, including by way of embodiment a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described herein can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit) to name a few.

Processors suitable for the execution of a computer program include, by way of embodiment, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms data memory including nonvolatile memory, media and memory devices, including by way of embodiment semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user and as shown in the Figures contained herein, embodiments described herein can be implemented on a computer having a display device, e.g., an LCD (liquid crystal display) monitor, and the like for displaying information to the user and a keyboard and a pointing device, e.g., a mouse or a trackball, or a touch screen by which the user can provide input to the computer. Other kinds of devices can be used to provide for interaction with a user as well; for embodiment, input from the user can be received in any form, including acoustic, speech, or tactile input.

Embodiments described herein can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described herein, or any combination of one or more such back end, middleware, or front end components. The components of the system can be interconnected by any form or medium of digital data communication, e.g., a communication network. Embodiments of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other

FIGS. 5 and 6 demonstrate test results from alternative test methods of determining flow of molten glass. In each of FIGS. 5 and 6, the horizontal or X-axis represents time and the vertical or Y-axis represents molten glass flow. Plot 501 in FIG. 5 represents the estimated molten glass flow rate from one test method where the thickness of the edge portions 223a, 223b of the glass ribbon 103 were assumed to be a certain multiple (e.g., from 1.5-2.0) of the thickness 217 of the central portion 219 of the glass ribbon 103. Plot 503 in FIG. 5 represents the actual molten glass flow rate. It can be observed that there are errors in the estimated molten glass flow rate based on this test method where the thickness of the edge portions 223a, 223b of the glass ribbon 103 were assumed to be a certain multiple of the thickness 217 of the central portion 219 of the glass ribbon 103. In particular, errors in the estimated molten glass flow rate can be seen, for example, towards the right-side of FIG. 5 as the estimation discrepancy becomes larger towards the end of the evaluation period.

Plot 601 in FIG. 6 represents the estimated molten glass flow rate using methods of the disclosure, including estimating a thickness of the glass ribbon 103 based on a sensed temperature of the glass ribbon 103 and then estimating the molten glass flow rate based on the estimated thickness. Plot 603 represents the actual molten glass flow rate. As shown, the estimated molten glass flow rate of plot 601, which was determined by estimating a thickness of the glass ribbon 103 based on a sensed temperature of the glass ribbon 103 and then estimating the molten glass flow rate based on the estimated thickness, more closely follows the plot 603 of the actual molten glass flow rate when compared with the estimated molten glass flow rate of the alternative method depicted in FIG. 5 which was determined by estimating the thickness of the edge portions 223a, 223b of the glass ribbon 103 to be a certain multiple of the thickness 217 of the central portion 219 of the glass ribbon 103.

It is to be understood that, as used herein the terms “the,” “a,” or “an,” mean “at least one,” and should not be limited to “only one” unless explicitly indicated to the contrary. Thus, for example, reference to “a component” includes examples having two or more such components unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It will be apparent to those skilled in the art that various modifications and variations can be made to the present disclosure without departing from the spirit and scope of the application. Thus, it is intended that the present application cover the modifications and variations of this disclosure provided they come within the scope of the appended claims and their equivalents.

1. A glass manufacturing apparatus comprising:
a glass former to form a glass ribbon from a quantity of molten material;
a thermal sensor oriented to sense a temperature of the glass ribbon; and
a processor programmed to estimate a thickness of the glass ribbon based on the sensed temperature from the thermal sensor.

2. The glass manufacturing apparatus of claim 1, further comprising:
a controller to operate the glass former based on the estimated thickness of the glass ribbon.

3. The glass manufacturing apparatus of claim 1, wherein the thermal sensor comprises an infrared sensor.

4. The glass manufacturing apparatus of claim 1, wherein the thermal sensor comprises a thermal camera oriented to sense a corresponding temperature of the glass ribbon at a plurality of locations, and wherein each of the plurality of locations corresponds to at least one pixel of the thermal camera.

5. The glass manufacturing apparatus of claim 1, wherein the thermal sensor is oriented to sense a corresponding temperature of the glass ribbon at a plurality of locations along a first path transverse to a draw direction, and wherein the processor is programmed to estimate a corresponding thickness of the glass ribbon at each of the plurality of locations based on the corresponding sensed temperature from the thermal sensor.

6. The glass manufacturing apparatus of claim 5, wherein the thermal sensor is oriented to sense a corresponding change in temperature of the glass ribbon at a plurality of locations along a plurality of second paths along the draw direction, wherein each of the plurality of second paths intersects the first path, and wherein the processor is programmed to estimate a corresponding thickness of the glass ribbon at each of the plurality of locations along the first path based on the corresponding sensed temperature of the glass ribbon at the plurality of locations along the first path from the thermal sensor and the corresponding sensed change in temperature of the glass ribbon along the plurality of second paths from the thermal sensor.

7. The glass manufacturing apparatus of claim 1, wherein the processor is programmed to estimate the thickness (t) of the glass ribbon as a function of the relationship:
$$\frac{t}{2} v ρ {C}_{p} ( \frac{d}{dy} T ) = - h ( T - {T}_{a} ) + ɛσ ( {T}^{4} - {T}_{a}^{4} ) + k$$
wherein,
v represents a velocity of the glass ribbon along a draw direction;
ρ represents a density of a material of the glass ribbon;
Cₚ represents a heat capacity of the material of the glass ribbon;
y represents a coordinate in the draw direction;
T represents the sensed temperature of the glass ribbon from the thermal sensor;
h represents a convective heat transfer coefficient of the glass ribbon;
Tₐ represents a temperature of an ambient and radiative environment of the glass ribbon;
s represents an emissivity of the glass ribbon;
σ represents the Stefan-Boltzmann constant; and
k represents a corrective term of the convective heat transfer coefficient,
and further comprising:
a thickness sensor to sense a thickness of the glass ribbon, wherein the convective heat transfer coefficient (h) of the glass ribbon is estimated as a function of the relationship:
$$h = \frac{ɛσ ( {T}^{4} - {T}_{a}^{4} ) + k - \frac{τ}{2} v ρ {C}_{p} ( \frac{d}{dy} T )}{( T - {T}_{a} )}$$
wherein,
τ represents the sensed thickness of the glass ribbon from the thickness sensor,
wherein the corrective term (k) of the convective heat transfer coefficient is estimated to be within a range of:
$$0 \leq k \leq \frac{c}{2} ( τ \frac{{d}^{2} T}{{dx}^{2}} + \frac{d τ}{dx} \frac{dT}{dx} )$$
wherein,
c represents a thermal conductivity coefficient of the material of the glass ribbon; and
X represents a coordinate transverse to the draw direction.

8. The glass manufacturing apparatus of claim 1, wherein the thermal sensor is oriented to sense a temperature of at least one of two opposed edge portions of the glass ribbon, and wherein the processor is programmed to estimate a thickness of at least one of the two opposed edge portions of the glass ribbon based on the sensed temperature of the at least one of the two opposed edge portions of the glass ribbon.

9. A method of manufacturing glass comprising the steps of:
forming a glass ribbon from a quantity of molten material;
sensing a temperature of the glass ribbon; and
estimating a thickness of the glass ribbon based on the sensed temperature.

10. The method of claim 9, further comprising at least one step selected from the following:
operating a glass former based on the estimated thickness of the glass ribbon;
adjusting a flow rate of the quantity of molten material based on the estimated thickness of the glass ribbon;
adjusting a temperature of the molten material based on the estimated thickness of the glass ribbon; and
adjusting a pull roll assembly based on the estimated thickness of the glass ribbon.

11. The method of claim 9, wherein the step of sensing a temperature of the glass ribbon comprises sensing a corresponding temperature of the glass ribbon at a plurality of locations along a first path transverse to a draw direction of the glass ribbon, and wherein the step of estimating the thickness of the glass ribbon comprises estimating a corresponding thickness of the glass ribbon at each of the plurality of locations based on the corresponding sensed temperature.

12. The method of claim 11, wherein the step of sensing a temperature of the glass ribbon comprises sensing a corresponding change in temperature of the glass ribbon at a plurality of locations along a plurality of second paths along the draw direction, wherein each of the plurality of second paths intersects the first path, and wherein the step of estimating the thickness of the glass ribbon comprises estimating a thickness of the glass ribbon at each of the plurality of locations along the first path based on the corresponding sensed temperature of the glass ribbon at the plurality of locations along the first path and the corresponding sensed change in temperature of the glass ribbon along the plurality of second paths.

13. The method of claim 9, comprising estimating the thickness (t) of the glass ribbon as a function of the relationship:
$$\frac{t}{2} v ρ {C}_{p} ( \frac{d}{dy} T ) = - h ( T - {T}_{a} ) + ɛσ ( {T}^{4} - {T}_{a}^{4} ) + k$$
wherein,
v represents a velocity of the glass ribbon along a draw direction;
ρ represents a density of a material of the glass ribbon;
Cₚ represents a heat capacity of the material of the glass ribbon;
y represents a coordinate in the draw direction;
T represents the sensed temperature of the glass ribbon;
h represents a convective heat transfer coefficient of the glass ribbon;
Tₐ represents a temperature of an ambient and radiative environment of the glass ribbon;
ε represents an emissivity of the glass ribbon;
σ represents the Stefan-Boltzmann constant; and
k represents a corrective term of the convective heat transfer coefficient,
and further comprising the steps of:
sensing a thickness of the glass ribbon, and estimating the convective heat transfer coefficient (h) of the glass ribbon as a function of the relationship:
$$h = \frac{ɛσ ( {T}^{4} - {T}_{a}^{4} ) + k - \frac{τ}{2} v ρ {C}_{p} ( \frac{d}{dy} T )}{( T - {T}_{a} )}$$
wherein,
τ represents the sensed thickness of the glass ribbon; and
estimating the corrective term (k) of the convective heat transfer coefficient to be within a range of:
$$0 \leq k \leq \frac{c}{2} ( τ \frac{{d}^{2} T}{{dx}^{2}} + \frac{d τ}{dx} \frac{dT}{dx} )$$
wherein,
c represents a thermal conductivity coefficient of the material of the glass ribbon; and
x represents a coordinate transverse to the draw direction.

14. A method of manufacturing glass comprising the steps of:
forming a glass ribbon from a quantity of molten material, wherein the glass ribbon comprises two opposed edge portions and a central portion disposed between the two opposed edge portions;
sensing a temperature of at least one of the two opposed edge portions of the glass ribbon; and
estimating a thickness of at least one of the two opposed edge portions of the glass ribbon based on the sensed temperature of the at least one of the two opposed edge portions of the glass ribbon.

15. The method of claim 14, further comprising the step of:
sensing a thickness of the central portion of the glass ribbon; and
sensing a temperature of the central portion of the glass ribbon, wherein the step of estimating the thickness of at least one of the two opposed edge portions of the glass ribbon is based on the sensed temperature of the at least one of the two opposed edge portions of the glass ribbon, the sensed temperature of the central portion of the glass ribbon, and the sensed thickness of the central portion of the glass ribbon.

16. The method of claim 14, further comprising the step of:
estimating a thickness of the glass ribbon along an entire width of the glass ribbon based on the sensed temperature of the at least one of the two opposed edge portions of the glass ribbon, the sensed temperature of the central portion of the glass ribbon, and the sensed thickness of the central portion of the glass ribbon.

17. The method of claim 14, further comprising the step of:
operating a glass former based on the estimated thickness of the at least one of the two opposed edge portions of the glass ribbon.

18. The method of claim 14, further comprising the step of:
adjusting a flow rate of the quantity of molten material based on the estimated thickness of the at least one of the two opposed edge portions of the glass ribbon.

19. The method of claim 14, further comprising the step of:
adjusting a temperature of the molten material based on the estimated thickness of the at least one of the two opposed edge portions of the glass ribbon.

20. The method of claim 14, further comprising the step of:
adjusting a pull roll assembly based on the estimated thickness of the at least one of the two opposed edge portions of the glass ribbon.
